(19) United States
(12) Patent Application Publication
(10) Pub. No.: US 2026/0129646 A1
(43) Pub. Date: May 7, 2026

(54) UL DUTY CYCLE IN WIRELESS COMMUNICATION SYSTEMS

(71) Applicant: Samsung Electronics Co., Ltd., Suwon-si (KR)

(72) Inventors: Marian Rudolf, Longueuil (CA); Aristides Papasakellariou, Houston, TX (US)

(21) Appl. No.: 19/358,383

(22) Filed: Oct. 14, 2025

Related U.S. Application Data
(60) Provisional application No. 63/715,295, filed on Nov. 1, 2024.

(51) Int. Cl. H04W 72/21; H04W 36/00

(52) U.S. Cl. CPC H04W 72/21; H04W 36/00692

(57) ABSTRACT

Apparatuses and methods for uplink (UL) transmission in wireless communication systems. A method for operating a user equipment (UE) includes receiving first information related to a first UL carrier and a second UL carrier, receiving second information associated with an UL duty cycle evaluation mode, determining, based on the first information, a first UL duty cycle associated with a first transmission on the first UL carrier; and determining, based on the first information, a second UL duty cycle associated with a second transmission on the second UL carrier. The method further includes determining, based on the first and second UL duty cycles, an UL duty cycle according to the second information, determining a power based on the UL duty cycle, and transmitting, based on the power, a signal or channel on the first or second UL carrier.

### CROSS REFERENCE TO RELATED APPLICATIONS AND CLAIM OF PRIORITY

The present application claims priority under 35 U.S.C. § 119(e) to U.S. Provisional Patent Application No. 63/715,295 filed on Nov. 1, 2024, which are hereby incorporated by reference in their entirety.

### TECHNICAL FIELD

The present disclosure relates generally to wireless communication systems and, more specifically, to uplink (UL) duty cycle in wireless communication systems.

### BACKGROUND

6th generation (6G) is recently gathering increased momentum with all the worldwide technical activities on the various candidate technologies from industry and academia. The candidate enablers for the 6G mobile communications include massive antenna technologies, from legacy cellular frequency bands up to high frequencies, to provide beamforming gain and support increased capacity, waveform design to flexibly accommodate various services/applications with different requirements, new multiple access schemes to support massive connections, AI/ML, and so on.

### SUMMARY

The present disclosure relates to UL duty cycle in wireless communication systems.

In one embodiment, a method for operating a UE is provided. The method includes receiving first information related to a first UL carrier and a second UL carrier, receiving second information associated with an UL duty cycle evaluation mode, determining, based on the first information, a first UL duty cycle associated with a first transmission on the first UL carrier; and determining, based on the first information, a second UL duty cycle associated with a second transmission on the second UL carrier. The method further includes determining, based on the first and second UL duty cycles, an UL duty cycle according to the second information, determining a power based on the UL duty cycle, and transmitting, based on the power, a signal or channel on the first or second UL carrier.

In another embodiment, a UE is provided. The UE includes a transceiver configured to receive first information related to a first UL carrier and a second UL carrier and receive second information associated with an UL duty cycle evaluation mode. The UE further includes a processor operably coupled to the transceiver. The processor is configured to determine, based on the first information, a first UL duty cycle associated with a first transmission on the first UL carrier, determine, based on the first information, a second UL duty cycle associated with a second transmission on the second UL carrier, determine, based on the first and second UL duty cycles, an UL duty cycle according to the second information, and determine a power based on the UL duty cycle. The transceiver is further configured to transmit, based on the power, a signal or channel on the first or second UL carrier.

In yet another embodiment, a base station (BS) is provided. The BS includes a processor and a transceiver operably coupled with the processor. The transceiver is configured to transmit first information related to a first UL carrier and a second UL carrier, transmit second information associated with an UL duty cycle evaluation mode, and receive a signal or channel on the first or second UL carrier. A first UL duty cycle is associated with a first transmission on the first UL carrier. A second UL duty cycle is associated with a second transmission on the second UL carrier. A power for transmission of the signal or channel is based on an UL duty cycle determined based on the first and second UL duty cycles according to the second information.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates an example timeline of a separate UL duty cycle evaluation in a first and a second band of a band combination for a wireless communication system according to embodiments of the present disclosure;

FIG. 11 illustrates an example flowchart for a process of a separate UL duty cycle evaluation in a first and a second band of a band combination for a wireless communication system according to embodiments of the present disclosure;

FIG. 12 illustrates an example flowchart for a process of a separate UL duty cycle evaluation in a first and a second band of a band combination to determine an UL maximum output power for a wireless communication system according to embodiments of the present disclosure;

FIG. 13 illustrates an example flowchart for a process of an effective UL duty cycle evaluation based on an adjustment factor in a band combination for a wireless communication system according to embodiments of the present disclosure;

FIG. 14 illustrates an example flowchart for a process of a second effective UL duty cycle evaluation based a first UL duty cycle evaluation and an adjustment factor in a band combination for a wireless communication system according to embodiments of the present disclosure; and

FIG. 15 illustrates an example method performed by a UE in a wireless communication system according to embodiments of the present disclosure.

### DETAILED DESCRIPTION

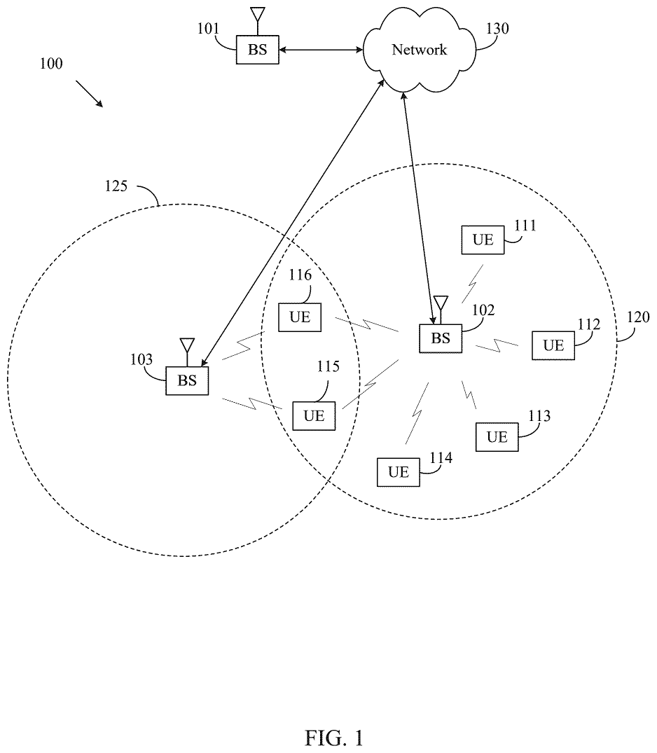

FIGS. 1-15 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G/LTE communication systems, and to enable various vertical applications, 5G/NR communication systems have been developed and are currently being deployed. The 5G/NR communication system can be implemented in higher frequency (mmWave) bands, e.g., 23-39 GHz or 60 GHz bands, so as to accomplish higher data rates or in lower frequency bands, such as 3.7/3.8 GHz, to enable robust coverage and mobility support. 6th generation (6G) cellular communications is recently gathering increased momentum with all the worldwide technical activities on the various candidate technologies from industry and academia. The candidate enablers for the 6G communication system include massive antenna technologies, from legacy cellular frequency bands up to high frequencies, to provide beamforming gain and support increased capacity, waveform design to flexibly accommodate various services/applications with different requirements, new multiple access schemes to support massive connections, AI/ML, and so on

The discussion of 6G systems and frequency bands associated therewith is for reference as certain embodiments of the present disclosure may be implemented in 6G systems. However, the present disclosure is not limited to 6G systems, or the frequency bands associated therewith, and embodiments of the present disclosure may be utilized in connection with any frequency band. For example, aspects of the present disclosure may also be applied to deployment of 6G communication systems, to deployment of 5G/NR communication systems, to deployment of 4G/LTE communication systems, or even for deployments which may use terahertz (THz) bands in later releases.

The following documents are hereby incorporated by reference into the present disclosure as if fully set forth herein: 3GPP TS 38.211 v18.4.0, “NR; Physical channels and modulation” (REF1); 3GPP TS 38.212 v18.4.0, “NR; Multiplexing and Channel coding” (REF2); 3GPP TS 38.213 v18.4.0, “NR; Physical Layer Procedures for Control” (REF3); 3GPP TS 38.214 v18.4.0, “NR; Physical Layer Procedures for Data” (REF4); 3GPP TS 38.321 v18.3.0, “NR; Medium Access Control (MAC) protocol specification” (REF5); 3GPP TS 38.331 v18.3.0, “NR; Radio Resource Control (RRC) Protocol Specification” (REF6); 3GPP TS 38.101-1 v18.7.0, “NR; UE radio transmission and reception; Part 1: Range 1 Standalone” (REF7); 3GPP TS 38.101-2 v18.7.0, “NR; UE radio transmission and reception; Part 2: Range 2 Standalone” (REF8); 3GPP TS 38.101-3 v18.7.0, “NR; UE radio transmission and reception; Part 3: Range 1 and Range 2 Interworking operation with other radios” (REF9); 3GPP TS 38.133 v18.7.0, “NR; Requirements for support of radio resource management” (REF10); 3GPP TS 36.213 v18.2.0, “E-UTRA; Physical Layer Procedures” (REF11); 3GPP TS 38.300 v18.3.0, “NR and NG-RAN Overall Description (Stage 2)” (REF12); and 3GPP TS 37.340 v18.3.0, “E-UTRA and NR; Multi-connectivity; Overall Description (Stage 2)” (REF13).

Various of the figures and discussion below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 6G, 5G/new radio (NR), 4G/long term evolution (LTE) or long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6G base station, a macrocell, a femtocell, a WiFi access point (AP), or other wirelessly enabled devices. Base stations may provide wireless access in accordance with one or more wireless communication protocols, e.g., 6G, 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or a vending machine or a fixed wireless access node).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for determining UL duty cycle in wireless communication systems. In certain embodiments, one or more of the BSs 101-103 include circuitry, programing, or a combination thereof to support determination of UL duty cycle in wireless communication systems. Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

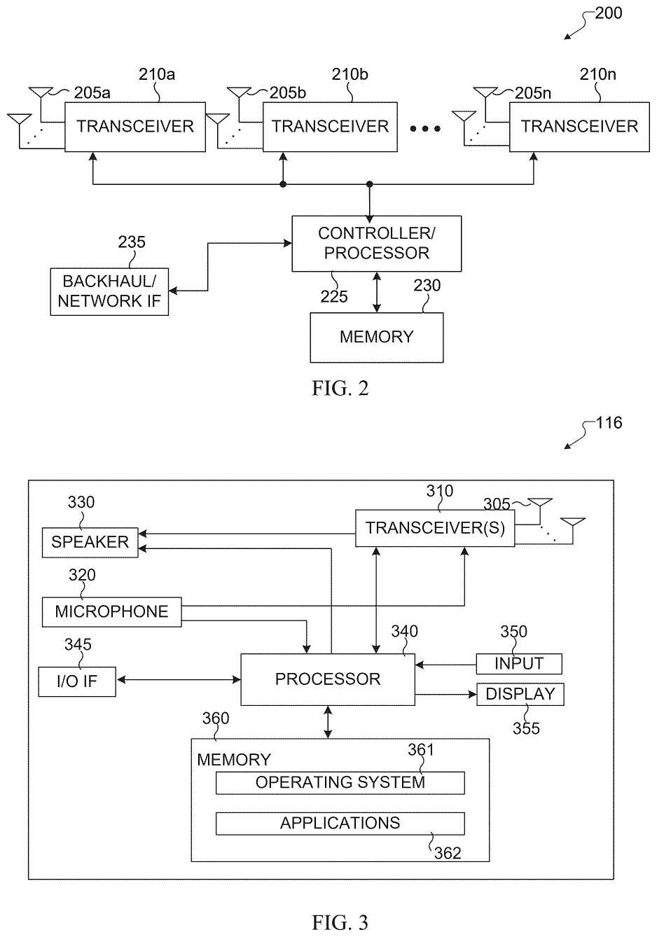

FIG. 2 illustrates an example TRP 200 according to embodiments of the present disclosure. For example, the TRP 200 any be a base station, such as gNB 101-103, or may be an NCR or smart repeater (SR). The embodiment of the TRP 200 illustrated in FIG. 2 is for illustration only. However, TRPs come in a wide variety of configurations, and FIG. 2 does not limit the scope of the present disclosure to any particular implementation of a TRP.

As shown in FIG. 2, the TRP 200 includes multiple antennas 205a-205n, multiple transceivers 210a-210n, a controller/processor 225, a memory 230, and a backhaul or network interface 235. The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

For example, in embodiments where the TRP is a repeater, one or more of the transceivers 210 may be used for an NCR-RU entity or NCR-Fwd entity as a DL connection for signaling over an access link with a UE and/or over a backhaul link with a gNB. In these examples, the associated one(s) of the transceivers 210 for the NCR-RU entity or NCR-Fwd entity may not covert the incoming RF signal to IF or a baseband signal but rather amplify the incoming RF signal and forward or relay the amplified signal, without any down conversion to IF or baseband. In another example, in embodiments where the TRP is a repeater, one or more of the transceivers 210 may be used for an NCR-MT entity as a DL or UL connection for control signaling over a control link (C-link) with a gNB.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the TRP 200. For example, the controller/processor 225 could control the reception of UL channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for determining UL duty cycle in wireless communication systems. Any of a wide variety of other functions could be supported in the TRP 200 by the controller/processor 225.

The controller/processor 225 is also capable of executing programs and other processes resident in the memory 230, such as processes to support transmission power in a wireless communication system. The controller/processor 225 can move data into or out of the memory 230 as required by an executing process.

The controller/processor 225 is also coupled to the backhaul or network interface 235. The backhaul or network interface 235 allows the TRP 200 to communicate with other devices or systems over a backhaul connection or over a network. The interface 235 could support communications over any suitable wired or wireless connection(s). For example, when the TRP 200 is implemented as part of a cellular communication system (such as one supporting 6G, 5G/NR, LTE, or LTE-A), the interface 235 could allow the TRP 200 to communicate with other gNBs over a wired or wireless backhaul connection, for example, using a transceiver, such as described above with regard to transceivers 210. For example, in embodiments where the TRP is a repeater, the interface 235 may be used for an NCR-RU or NCR-Fwd entity as a backhaul connection with a gNB over a backhaul link for control signaling and/or data to be transmitted to and/or received from a UE. When the TRP 200 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of TRP 200, various changes may be made to FIG. 2. For example, the TRP 200 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for determining UL duty cycle in wireless communication systems as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

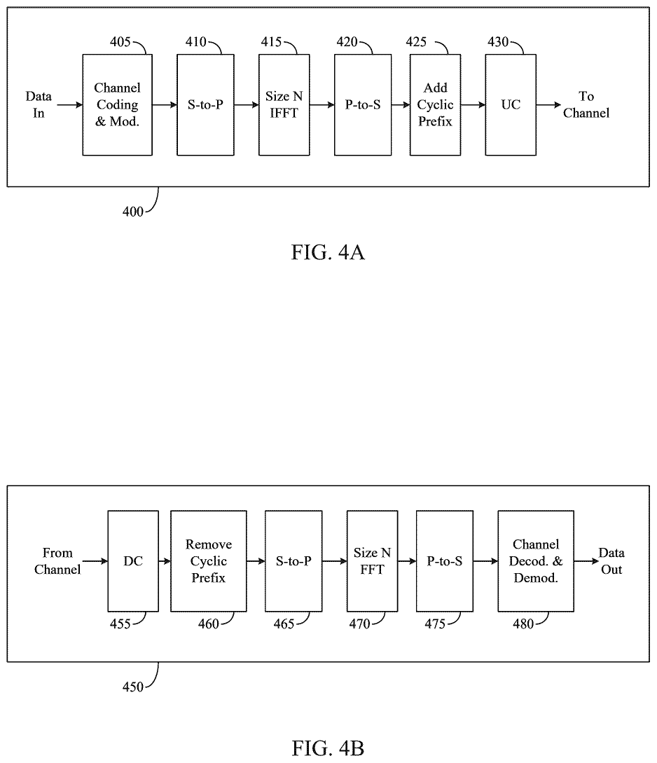

FIG. 4A and FIG. 4B illustrate an example of wireless transmit and receive paths 400 and 450, respectively, according to embodiments of the present disclosure. For example, a transmit path 400 may be described as being implemented in a gNB or TRP (such as gNB 102 or TRP 200), while a receive path 450 may be described as being implemented in a UE (such as UE 116). However, it will be understood that the receive path 450 can be implemented in a gNB or TRP and that the transmit path 400 can be implemented in a UE. In some embodiments, the transmit path 400 and/or the receive path 450 is configured for operation in a 6G or 5G/NR or 4G/LTE in a wireless communication system as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 or the TRP 200 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 or the TRP 200 and may implement a receive path 450 for receiving in the downlink from gNBs 101-103 or the TRP 200.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

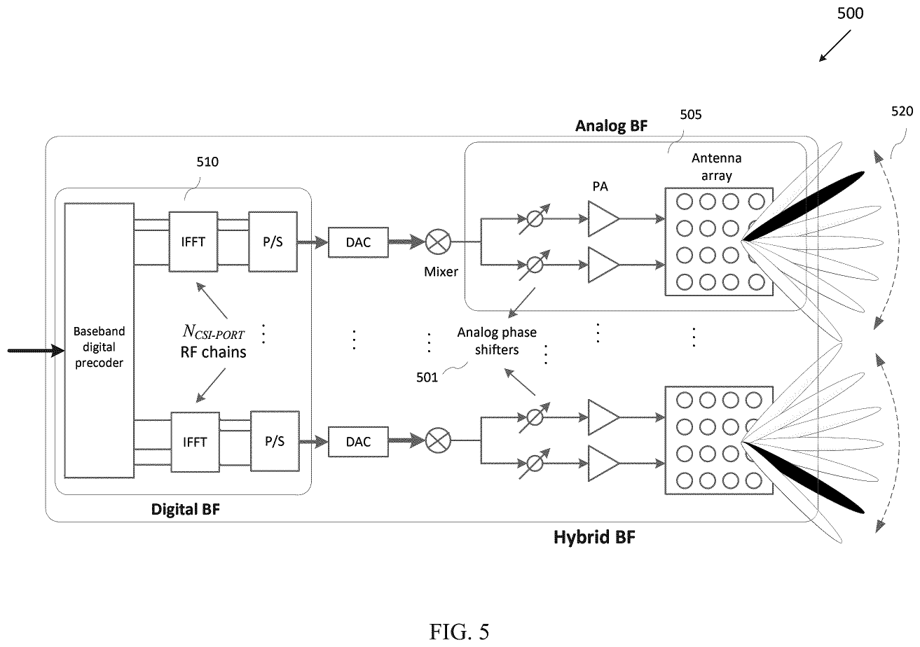

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

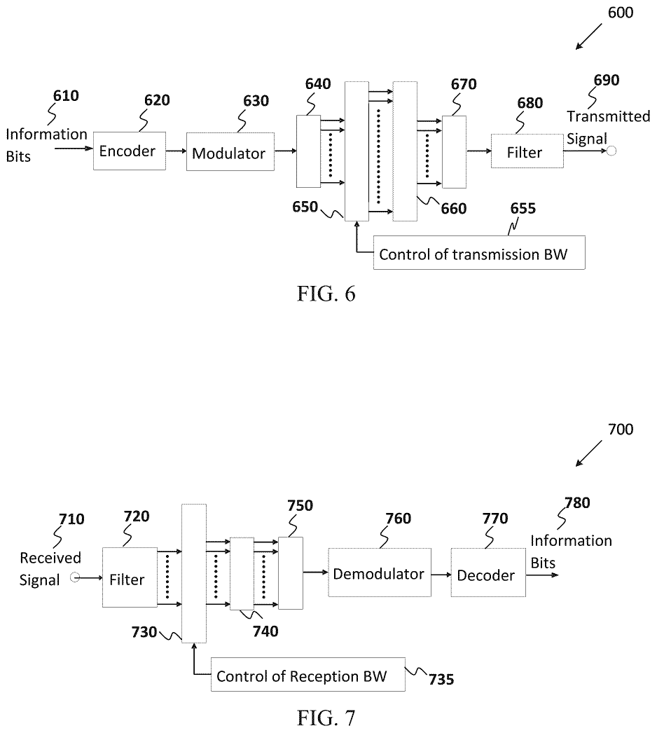

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a demodulation reference signal (DMRS) or a CRS (not shown), and a decoder 770, such as a turbo decoder or a low-density-parity-check (LDPC) decoder, decodes the demodulated data to provide an estimate of the information data bits 780. Additional functionalities such as time-windowing, cyclic prefix removal, de-scrambling, channel estimation, and de-interleaving are not shown for brevity.

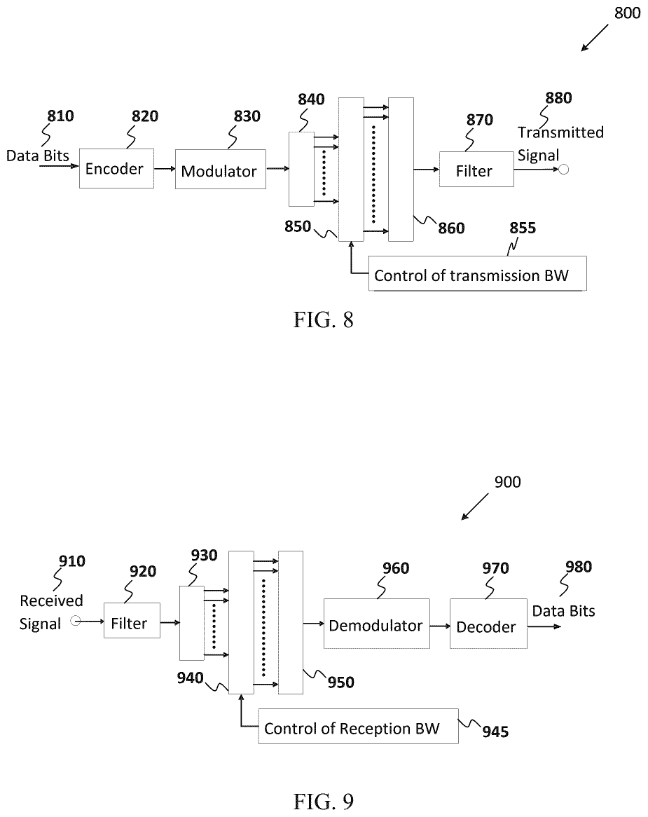

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder or a low-density-parity-check (LDPC) decoder, decodes the demodulated data to provide an estimate of the information data bits 980.

A communication system can include a downlink (DL) that refers to transmissions from a base station (such as the BS 102) or one or more transmission points to UEs (such as the UE 116) and an UL that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency or bandwidth (BW) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with cyclic redundancy check (CRC) scrambled by cell-radio network temporary identifier (C-RNTI/configured scheduling RNTI (CS-RNTI)/modulation and coding scheme (MCS)-C-RNTI as described in REF2, are referred for brevity as a unicast DCI format. A DCI format scheduling PDSCH reception for multicast communication, such as a DCI format with CRC scrambled by group (G)-RNTI/G-CS-RNTI as described in REF2, are referred to as multicast DCI format. DCI formats providing various control information to at least a subset of UEs in a serving cell, such as DCI format 2_0 in REF2, are referred to as group-common (GC) DCI formats.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA. A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes hybrid automatic repeat request (HARQ) acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a synchronization signal/physical broadcast channel (SS/PBCH) block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as synchronization signal blocks (SSBs)) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are quasi co-location (QCL) with QCL type A, type D (when applicable) and average gain. The UE may further assume that no DM-RS collides with the SS/PBCH block.

A beam may be determined by a transmission configuration indication (TCI) state that establishes a quasi-co-location (QCL) relationship or a spatial relation between a source reference signal, e.g., a synchronization signal block (SS/PBCH Block or SSB) or channel state information reference signal (CSI-RS) and a target reference signal, or a spatial relationship information that establishes an association to a source reference signal, such as an SSB, CSI-RS, or sounding reference signal (SRS). In either case, the ID of the source reference signal can identify the beam.

The TCI state and/or the spatial relationship reference RS can determine a spatial Rx filter for reception of downlink channels or signals at the UE, or a spatial Tx filter for transmission of uplink channels or signals from the UE. The TCI state and/or the spatial relation reference RS can determine a spatial Tx filter for transmission of downlink channels or signals from the gNB, or a spatial Rx filter for reception of uplink channels or signals at the gNB.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

A quasi-co-location (QCL) relationship may be configured by the higher layer parameter qcl-Type1 for a first DL RS, and qcl-Type2 for a second DL RS (if configured). For the case of two DL RSs, the QCL types may not be the same, regardless of whether the references are to the same DL RS or different DL RSs. The quasi-co-location types corresponding to each DL RS can be given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}. A reference RS may correspond to a set of characteristics of a DL beam or an UL Tx beam, such as a direction, a precoding/beamforming, a number of ports, and so on.

A UE can be provided through higher layer RRC signaling a set of TCI States with N elements. In one example, DL and joint TCI states are configured by higher layer parameter DLorJoint-TCIState, wherein, the number of DL and Joint TCI state is N_{DJ}. UL TCI states are configured by higher layer parameter UL-TCIState, wherein the number of UL TCI states is N_{U}. N=N_{DJ}+N_{U}. The DLorJoint-TCIState can include DL or Joint TCI states for a serving cell. The source RS of the TCI state may be associated with the serving cell, e.g., the physical cell ID (PCI) of the serving cell. Additionally, the DL or Joint TCI states can be associated with a cell having a PCI different from the PCI of the serving cell, e.g., the source RS of the TCI state is associated with a cell having a PCI different from the PCI of the serving cell. The UL-TCIState can include UL TCI states that belong to a serving cell, e.g., the source RS of the TCI state is associated with the serving cell (the PCI of the serving cell); additionally, the UL TCI states can be associated with a cell having a PCI different from the PCI of the serving cell, e.g., the source RS of the TCI state is associated with a cell having a PCI different from the PCI of the serving cell.

MAC CE signaling can include a subset of M (M≤N) TCI states or TCI state code points from the set of N TCI states, wherein a code point is signaled in the “transmission configuration indication” field of a DCI used for indication of the TCI state. A codepoint can include one TCI state, e.g., DL TCI state or UL TCI state or Joint (DL and UL) TCI state. Alternatively, a codepoint can include two TCI states, e.g., a DL TCI state and an UL TCI state. L1 control signaling, i.e., Downlink Control Information (DCI) can update the UE's TCI state, wherein the DCI includes a “transmission configuration indication” (beam indication) field, e.g., using m bits such that M≤2^{m}. The TCI state may correspond to a code point signaled by MAC CE. A DCI used for indication of the TCI state can be a DCI format 1_1 or DCI format 1_2 or DCI format 1_3 with a DL assignment for PDSCH receptions or without a DL assignment for PDSCH receptions.

The TCI states can be associated through a QCL relation with an SSB or a CSI-RS of serving cell, or an SSB or a CSI-RS associated with a PCI different from the PCI of the serving cell. The QCL relation with an SSB can be a direct QCL relation, wherein the source RS, e.g., for a QCL Type D relation or a spatial relation of the QCL state is the SSB. The QCL relation with an SSB can be an indirect QCL relation wherein the source RS, e.g., for a QCL Type D relation or a spatial relation can be a CSI-RS and the CSI-RS has the SSB as its source, e.g., for a QCL Type D relation or a spatial relation. The indirect QCL relation to an SSB can involve a QCL or spatial relation chain of more than one CSI-RS.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous physical resource blocks (PRBs) which represents the smallest frequency unit for CSI or calibration coefficient reporting. The number of PRBs in a subband can be fixed for a given value of DL system bandwidth, configured either semi-statically via higher layer/RRC signaling, or dynamically via L1 DL control signaling or MAC control element (MAC CE). The number of PRBs in a subband can be included in CSI or calibration coefficient reporting setting. The term “CSI reporting band” is defined as a set/collection of subbands, either contiguous or non-contiguous, wherein CSI or calibration coefficient reporting is performed. For example, CSI or calibration coefficient reporting band can include the subbands within the DL system bandwidth. This can also be termed “full-band”. Alternatively, CSI or calibration coefficient reporting band can include only a collection of subbands within the DL system bandwidth. This can also be termed “partial band”. The term “CSI reporting band” is used only as an example for representing a function. Other terms such as “CSI reporting subband set” or “CSI or calibration coefficient reporting bandwidth” can also be used.

In terms of UE configuration, a UE can be configured with at least one CSI or calibration coefficient reporting band. This configuration can be semi-static (via higher layer signaling or RRC) or dynamic (via MAC CE or L1 DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for the Mₙ subbands within the CSI reporting band. A CSI parameter is configured with “subband” for the CSI reporting band with Mn subbands when one CSI parameter is reported for each of the Mn subbands within the CSI reporting band.

In the following and throughout the disclosure, various embodiments of the disclosure may be also implemented in any type of UE including, for example, a 6G UE, or a UEs with the same, similar, or more capabilities compared to a Rel-21 6G or a 5G/NR UEs. Although various embodiments of the disclosure discuss 3GPP 6G 5G/NR wireless communication systems, the embodiments may apply in general to UEs operating with other RATs and/or standards, such as next releases/generations of 3GPP, IEEE Wi-Fi, and so on.

The term ‘activation’ describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

In the following, unless otherwise explicitly noted, providing a parameter value by higher layers includes providing the parameter value by a system information block (SIB), such as a SIB1, or by a common RRC signaling, or by UE-specific RRC signaling, or by core network signaling between a UE and a network node.

In the following, the suffix ‘-rxx’ is used to denote a parameter that does not currently exist in specifications and can be introduced to support the disclosed functionalities, with ‘xx’ denoting a number of a 3GPP release for the introduction of the parameter, e.g., xx=20 for Rel-20, or xx=21 for Rel-21, etc.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with an SCell or additional SCGs by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration designates a slot or symbol as one of types ‘D’, ‘U’ or ‘F’ using at least one time-domain pattern with configurable periodicity.

In the following, for brevity of description, SFI refers to a slot format indicator as example that is indicated using higher layer provided IEs such as slotFormatCombination or slotFormatCombinationsPerCell and which is indicated to the UE by group common DCI format such as DCI F2_0 where slotFormats are defined in REF3 when using 5G/NR.

In certain embodiments, a TCI state may be used for beam indication. A TCI state may refer to a DL TCI state for DL channels, e.g. PDCCH or PDSCH, an UL TCI state for UL channels, e.g. PUSCH or PUCCH, a joint TCI state for DL and UL channels, or separate TCI states for UL and DL channels or signals. A TCI state may be common across multiple component carriers or may be a separate TCI state for a component carrier of a set of component carriers. A TCI state may be gNB or UE panel specific or common across panels. In some examples, an UL TCI state may be replaced by an SRS resource indicator (SRI).

Terminology such as TCI, TCI states, SpatialRelationInfo, target RS, reference RS, and other terms is used for illustrative purposes and is therefore not normative. Other terms that refer to same functions can also be used. A “reference RS” corresponds to a set of characteristics of a DL RX beam or an UL TX beam, such as a direction, a precoding/beamforming, a number of ports, and so on. A beam may also be referred to as spatial filter or spatial setting and be associated with a TCI state for quasi co-location (QCL) properties.

In certain embodiments, a cell may include more than one transmission/reception point (TRP). For example, mTRP operation may be referred to as intra-cell mTRP operation. In one example, a TRP may be identified by a CORESETPoolIndex associated with CORESETs for PDCCH receptions. In one example, a TRP may be identified by a group (e.g., one or more) SS/PBCH blocks (SSBs). For example, a first group or set of SSBs belong to or determine or identify a first TRP, a second group or set of SSBs belong to or determine or identify a second TRP, and so on. In one example, a TRP may be identified by a group (e.g., one or more) channel state information reference signal (CSI-RS) resources or CSI-RS resource sets. For example, a first group or set of CSI-RS resources or CSI-RS resource sets belong to or determine or identify a first TRP, a second group or set of CSI-RS resources or CSI-RS resource sets belong to determine or identify a second TRP, and so on. In one example, a TRP may be identified by a group (e.g., one or more) antenna ports. For example, a first group or set of antenna ports belong to or determine or identify a first TRP, a second group or set of antenna ports belong to determine or identify a second TRP, and so on. In one example, a TRP is identified or determined following one or more of the previous examples. In one example, a TRP may be identified by a group (e.g., one or more) sounding reference signal (SRS) resources or SRS resource sets. For example, a first group or set of SRS resources or SRS resource sets belong to or determine or identify a first TRP, a second group or set of SRS resources or SRS resource sets belong to or determine or identify a second TRP, and so on. In one example, a TRP may be identified by a group (e.g., one or more) TCI states (UL TCI states or DL TCI states or Joint TCI states or TCI state codepoints). For example, a first group or set of TCI states belong to or determine or identify a first TRP, a second group or set of TCI states belong to or determine or identify a second TRP, and so on.

In certain embodiments, the term “FR1” or a frequency range designation “FR1” may refer to a corresponding frequency range 410-7125 MHz; the term “FR2-1” or a frequency range designation “FR2-1” may refer to a corresponding frequency range 24250-52600 MHz; the term “FR2-2” or a frequency range designation “FR2-2” may refer to a corresponding frequency range 52600-71000 MHz; the term “FR2” or a frequency-range designation “FR2” may refer to FR2-1 or FR2-2.

In certain embodiments, the term “FR3” or a frequency range designation “FR3” may refer to a corresponding frequency range 7125-24250 MHz, or parts thereof. For example, an FR3 band may correspond to 7125-8400 MHz, or parts thereof, in ITU Region 2 or ITU Region 3. For example, an FR3 band may correspond to 7125-7250 MHz or 7750-8400 MHz, or parts thereof, in ITU Region 1. For example, an FR3 band may correspond to 14800-15350 MHz, or parts thereof, in an ITU Region. For example, for simplicity and illustration purposes, the term “FR3 7-8 GHz” may be used to refer to 6G radio access on a carrier or in a band of a frequency range such as 7125-8400 MHz, or the term “FR3 14-15 GHz” may be used to refer to 6G radio access on a carrier or in a band of a frequency range such as 14800-15350 MHz. The term “FR3 7-8 GHz” may be used interchangeably with a term such as “FR3 band 7-8 GHz” or “6G band 7-8 GHz”.

In certain embodiments, 6G radio access may be supported on a carrier or in a band of a frequency range such as FR1 corresponding to 4400-4800 MHz, or in a carrier or in a band corresponding to an FR1 or an FR2 operating band as defined in REFS7-9. For example, the term “FR1 4 GHz” may be used interchangeably with a term such as “FR1 band 4 GHz” or “6G band 4 GHz”.

In certain embodiments, 5G/NR or 4G/LTE radio access may be supported on a carrier or in a band of a frequency range corresponding to an FR1 operating band, or 5G/NR radio access may be supported on a carrier or in a band of an FR2 operating band such as defined in REFS7-9 for 5G/NR.

In certain embodiments, a UE supporting 6G radio access may operate in single RAT mode or may operate in dual RAT mode.

For example, when operating in single RAT mode, the UE may select one RAT, e.g., one of 4G/LTE or 5G/NR or 6G radio access to (re-)select and camp on a serving cell in a band when in RRC_IDLE or RRC_INACTIVE state. For example, when operating in single RAT mode, the UE may be indicted one or more serving cells corresponding to one RAT in one or more bands by the network using mobility or handover procedures when in RRC_CONNECTED state. For example, a UE supporting 6G radio access and operating in single RAT mode may also support 4G/LTE or 5G/NR radio access or may also support other wireless radio access such as Wi-Fi or Bluetooth or UWB.

For example, a dual RAT mode may be based on carrier aggregation operation, or dual connectivity operation or dual active protocol stack operation. For example, when operating in dual RAT mode, a multiple Rx and/or multiple Tx capable UE may be concurrently or simultaneously active on two serving cells using a separate RAT for each serving cell, respectively, wherein a first RAT may correspond to 6G radio access, and a second RAT corresponds to one of 5G/NR radio access or 4G/LTE radio access. For example, when operating in dual RAT mode, the UE may be indicated with a first cell group comprising one or more serving cells corresponding to the first RAT, and a second cell group comprising one or more serving cells corresponding to the second RAT. For example, the first cell group may correspond to an MCG and the second cell group may correspond to an SCG with reference to carrier aggregation or dual connectivity. Serving cells or cell groups may be located in a same or in different bands. For example, a UE supporting 6G radio access and operating in dual RAT mode may also support 4G/LTE or 5G/NR radio access or may also support other wireless radio access.

For example, when operating in dual RAT mode based on principles such as described in REF11 for multi-RAT dual-connectivity operation for scenarios such as LTE-NR or NR-LTE or NR-NR, a UE supporting 6G radio access may be configured to utilize radio resources provided by two different nodes connected via non-ideal or ideal backhaul, one node providing 6G radio access and the other node providing either 4G/LTE or 5G/NR radio access. One node may act as a master node (MN) and the other as secondary node (SN), where the MN and SN are connected via a network interface and at least the MN is connected to the core network. Transmissions to the UE or receptions from the UE using 4G/LTE or 5G/NR radio access may then occur on a primary cell group (PCG), and transmissions to the UE or receptions from the UE using 6G radio access may then occur on a secondary cell group (SCG). In another example, 6G radio access may occur on the PCG and 4G/LTE or 5G/NR radio access may occur on the SCG. For example, when operating in dual RAT mode based on carrier aggregation, if supported by 6G radio access, the UE supporting 6G radio access may be scheduled per cell group and network-side scheduling between the first and the second cell group, respectively, may or may not be coordinated between the cell groups.

For example, when operating in dual RAT mode based on dual active protocol stack operation, the UE supporting 6G radio access may be connected to a 6G serving cell in a first band while being connected to a 4G/LTE or 5G/NR cell in a second band. In one example, a dual-active protocol stack UE maintains separate RRC states with respect to the radio access network, i.e., a first RRC state corresponding to the 6G radio access and a second RRC state corresponding to the 5G/NR or the 4G/LTE radio access. In one example, a dual-active protocol stack UE may maintain a same or separate mobility or connection states with respect to the core network, i.e., a first mobility or connection management state corresponding to the 6G radio access and a second mobility or connection state corresponding to the 5G/NR or the 4G/LTE radio access.

In certain embodiments, a UE supporting 6G radio access may transmit or receive on a carrier or in a band of a band combination according to carrier aggregation operation, or according to dual connectivity operation, or according to dual active protocol stack operation. Without loss of generality and for conciseness of description, the term “band combination” may refer to a band combination such as defined with respect to a carrier-aggregation band combination, or such as a dual connectivity band combination, or such as a dual active protocol stack band combination. For example, a UE supporting 6G radio access may operate in FDD mode or in TDD mode on a carrier or in a band. For example, the UE supporting 6G radio access may operate in a combination of FDD and/or TDD modes in a band or in a band combination.

In certain embodiments, the UE supporting 6G radio access may transmit or receive on a carrier or in a band of a band combination according to carrier aggregation operation, or according to dual connectivity operation, or according to dual active protocol stack operation using a single UL carrier or using two or more UL contiguous or non-contiguous carriers. For example, based on single UL carrier operation, the UE supporting 6G radio access may transmit an UL signal or channel in a first UL carrier corresponding to 6G radio access or may transmit an UL signal or channel in a second UL carrier corresponding to 5G/NR radio access but the UL transmissions on the first and the second UL carrier then may occur separately in time-domain, e.g., in different slots or symbols, respectively, and the UE may switch between UL transmissions in the first and the second UL carrier, respectively. For example, the UE supporting 6G radio access may be capable of simultaneous UL transmission in two or more UL carriers in a same band or in different bands of a band combination. For example, a UE supporting 6G radio access using a single carrier or using two or more UL carriers may support a switching or a simultaneous UL transmission capability with respect to some or all UL signals or channel types. For example, the UE may support switching with respect to an UL signal of type SRS. For example, the UE may support simultaneous UL transmission capability with respect to an UL channel of type PUSCH on two or more UL carriers.

The UE (e.g., the UE 116) needs to conform to regulatory requirements such as maximum permissible exposure (MPE) requirements to limit the total RF exposure experienced by a user. RF exposure can fall in two categories. A first category is the specific absorption rate (SAR). SAR applies to frequencies below 6 GHz. SAR is measured in units of Watts/kg and reflects the amount of power absorbed by a certain volume of tissue. A second category is power density (PD) and applies to frequencies above 6 GHz. PD is measured in units of Watts/cm² and reflects the amount of power incident on the surface of tissue. Using Rel-15 NR, SAR is used as metric when taking into account the FR1 band below 6 GHz and PD is used as metric when taking into account the FR2-1 (mmWave) bands.

For example, requirements from the FCC and the International Commission on Non-Ionizing Radiation Protection (ICNIRP) limit the MPE. Limits on SAR and PD are taken into account jointly. The individual SAR and PD values are normalized by the respective regulatory limits as seen in equation (E1):

$${\sum }_{i = 100 kHz}^{6 GHz} \frac{S A {R}_{i}}{S A {R}_{lim}} + {\sum }_{j = 6 GHz}^{300 GHz} \frac{P {D}_{j}}{P {D}_{lim}} \leq 1 \qquad ( E1 )$$

Here, SARᵢ refers to the time-averaged SAR in an RF band i and is determined according to equation (E2) where SARᵢ(τ) is the instantaneous SAR in band i. PDⱼ refers to the time-averaged PD in band j and is given by equation (E3) where PDⱼ(τ) is the instantaneous PD in band j. T_{SAR} and T_{PD} are the time windows for averaging, respectively. SARₗᵢₘ is a total regulatory limit for SAR. PDₗᵢₘ is a total regulatory limit for PD. Note that determination of the SAR and the PD is to include transmissions across frequencies and radio technologies of a UE, e.g., including Wi-Fi, or Bluetooth, or wireless transmission other than cellular radio when present.

$$S A {R}_{i} = \frac{1}{{T}_{S A R}} {\int }_{t - {T}_{S A R}}^{t} S A {R}_{i} ( τ ) d τ \qquad ( E2 )$$

$$P {D}_{j} = \frac{1}{{T}_{P D}} {\int }_{t - {T}_{P D}}^{t} P {D}_{j} ( τ ) d τ \qquad ( E3 )$$

The PD is typically measured over 4 cm² area and is limited to 1 mW/cm². A time averaging of 4 seconds can be used for frequencies from 24 GHz to 42 GHz. The SAR may be limited to 1.6 W/kg measured over 1 g of tissue. A time averaging window of 360 seconds can be used. Certain aspects of the measurement or evaluation procedure may vary across regulatory domains or countries.

The time averaging is an important UE implementation aspect when the UE monitors the RF exposure limits such as MPE. For example, the UE can monitor its wireless transmissions and determines or estimates the amount of generated RF exposure using a sliding time window for averaging. The UE can then determine an amount of allowable RF exposure such as MPE for a next period of time such as the next several hundred msec or the next 1 sec. The UE then uses an estimated, e.g., an allowable RF exposure limit to determine a maximum output power while adhering to the parameterization and closed-loop power-control commands from the gNB (e.g., the BS 102) according to the UL transmit power control procedure. For example, when an estimated or an allowable RF exposure limit is determined by the UE to be in excess of RF exposure limits, the UE may then use power class fallback or P-MPR based mitigation to reduce the RF exposure below acceptable levels using Rel-15 NR specifications as further described herein.

Using Rel-15 NR, a UE maximum transmit power or maximum output power can depend on a number of factors such as the UE maximum output power or UE power class (PC) and/or a power reduction that a UE is allowed under certain conditions.

A UE power class such as defined in REFS7-9 defines the maximum output power for any transmission bandwidth within the channel bandwidth of an NR carrier for FR1 or defines the maximum output power radiated by the UE for any transmission bandwidth within the channel bandwidth for FR2. For example, a UE power class may be specified or tested based on conducted or cabled measurements in FR1, or based on over-the-air (OTA) measurements in FR2. For example, the period of measurement may be at least one subframe (1 msec). For example, in the case of FR3, a UE power class may be defined according to FR1 for operating frequencies in the range of 6-8 GHz. For example, in the case of FR3, a UE power class may be defined according to FR2 for operating frequencies in the range of 13 GHz.

Using Rel-15 NR, several UE power classes are defined for FR1, such as power class 1 (PC1), power class 1.5 (PC1.5), power class 2 (PC2), power class 3 (PC3) or power class 4 (PC4). For example, UEs operating within FR1 typically support a maximum output power according to power class 3 (PC3), e.g., 23 dBm, or power class 2 (PC2), e.g., 26 dBm. PC3 may be regarded the default power class for FR1. Power classes 2 or 1.5 may only be applicable to specific operating bands such as applicable in NR bands n78 or n41 but not applicable in NR band n7. PC3 may be applicable for FR1 operating bands.

For example, with reference to 5G/NR and intra-band contiguous or non-contiguous carrier aggregation or inter-band carrier aggregation in FR1, current specifications as defined in REFS7-9 support operation according to PC2 or PC3 wherein PC2 is possible in some band combinations. For example, with reference to 5G/NR and NR inter-band dual-connectivity operation in FR1, current specifications as defined in REFS7-9 support operation according to PC3. For example, with reference to 5G/NR and LTE-NR dual connectivity operation (or EN-DC) in FR1 for the intra-band case, current specifications as defined in REFS7-9 support operation according to PC1.5, PC2 or PC3 wherein PC1.5 or PC2 are possible in some band combinations. For example, with reference to 5G/NR and LTE-NR dual connectivity operation (or EN-DC) in FR1 for the inter-band case, current specifications as defined in REFS7-9 support operation according to PC2 or PC3 wherein PC2 is possible in some band combinations. For example, with reference to 5G/NR and NR-LTE dual connectivity operation (or NE-DC) in FR1 for the inter-band case, current specifications as defined in REFS7-9 support operation according to PC3.

Using Rel-15 NR and for FR2, a maximum equivalent isotropic radiated power (EIRP) limit may be used to satisfy regulatory requirements, i.e. ensuring that the UE does not transmit at such high power that health issues would be caused or excessive interference would be caused. A maximum EIRP takes into account maximum antenna gain which can be generated by the FR2 UE. ‘Mobile’ UEs are specified to have a maximum EIRP of 43 dBm, while ‘transportable’ UEs are specified to have a maximum EIRP of 55 dBm according to REFS7-9. A minimum peak EIRP may be used to ensure that a UE can generate at least a minimum output power in one specific direction. A total radiated power (TRP) for a UE can define an upper limit on the total power radiated in directions. For example, UEs operating within FR2 may support a power class 1, 2, 3 or 4 wherein a power class can correspond to an assumed use case or application which is associated with each UE power class. For example, power class 1 (PC1), e.g., with maximum total radiated power (TRP) of 35 dBm and maximum peak EIRP of 55 dBm is intended for fixed wireless access (FWA) and has the highest transmit power capability. For example, power class 2 (PC2) for vehicular applications, power class 3 (PC3) for handheld UEs and power class 4 (PC4) for high-power non-handheld UEs can have equal maximum TRP of 23 dBm and maximum peak EIRP requirements of 43 dBm but different minimum peak EIRP requirements.

Using Rel-15 NR, a UE may be allowed a power reduction under certain conditions. For example, a first type of power reduction can be allowed for the UE to accommodate higher order modulations and/or transmit bandwidth configurations and may be referred to as maximum power reduction (MPR). A second type of maximum power reduction may be allowed for the UE to meet stringent spectral emission requirements and may be referred to as additional maximum power reduction (A-MPR). A third type of power reduction can be allowed for the UE to accommodate power management maximum power reduction (P-MPR) to comply with MPE requirements. More than one power reduction associated with different types may be applied by the UE for an UL transmission.

An MPR such as defined in REFS7-9 allows the UE to reduce the maximum output power due to higher order modulations and transmit bandwidth configurations. MPR can specify a power back-off for certain NR waveforms such as 16QAM or 64QAM and/or for location of the RBs in the operation band. The UE may not be able to generate and transmit a waveform for the maximum power according to the UE power class while also adhering to adjacent channel leakage ratio (ACLR), in-band emission (BE), error vector magnitude (EVM) and spectral emission mask (SEM) constraints. For example, MPR values provided in REFS7-9 are chosen such that a UE can still generate a waveform at a reasonable implementation complexity while respecting applicable ACLR, IBE, EVM and/or SEM requirements. For example, an MPR value may be used by the UE to calculate a lower bound on its P_{CMAX,f,c} value. The MPR value numbers may represent the maximum amount of power back-off which is allowed for the UE. The UE may or may not use such a maximum allowance when determining its UL transmit power for an UL transmission for as long as the UE can still meet applicable ACLR, IBE, EVM and/or SEM requirements.

An A-MPR is an additional maximum power reduction allowed for the maximum output power as specified in REFS7-9. For example, the total reduction to the UE maximum output power can be max(MPR, A-MPR). For example, an MPR and/or A-MPR can be based on an outer, inner or edge RB allocation, or a modulation and waveform type, or an associated network signaling label with further details provided in REFS7-9.

A P-MPR is power management maximum power reduction for serving cell. For example, P-MPR may be used by the UE for ensuring compliance with applicable electromagnetic energy absorption requirements such as MPE and/or addressing unwanted emissions or self-de-sense requirements in case of simultaneous transmissions on multiple radio access technologies (RAT(s)) or when proximity detection is used to address such requirements that would require a lower maximum output power. For example, based on the available maximum output transmit power and/or P-MPR of the UE, a gNB may adjust the scheduling decisions. For example, P-MPR may impact the maximum UL performance for the selected UL transmission path.

Using Rel-15 NR, for example, two approaches are for the UE implementation to autonomously reduce its maximum transmit power in order to adjust the UL transmissions according to RF exposure limits such as MPE. One approach is power class fallback when the UE supports a maximum transmit power higher than the default class. Another approach is to use the P-MPR allowance.

For example, using power class fallback, a PC2 UE can indicate to the gNB a maximum UL duty cycle up to which it is able to sustain the output power according to PC2 for its UL transmissions. For FR1, the maximum duty cycle is indicated by the parameter maxUplinkDutyCycle-PC2-FR1 in a UE capability message. When this parameter is not reported by a PC2-capable UE, it is expected to correspond to a default value, e.g., 50%. When UL scheduling occurs using dynamic and/or configured grants and the maximum duty cycle is exceeded, then the UE may operate as a PC3 UE. Similar instances apply to a PC1.5 capable UE. Power class fallback procedures to reduce a UE maximum output power may be used according to conditions such as further specified in REFS7-9. Similarly, P-MPR based behavior may be used by the UE in conjunction with a maximum UL duty cycle to reduce a UE maximum output power as defined in REFS7-9.

In one example for a FR1 PC2 or PC1.5 UE and intra-band contiguous EN-DC operation, if the UE supports a different power class than the default UE power class for the EN-DC band combination, and the supported power class enables higher maximum output power than that of the default power class: if the LTE UL/DL configuration is 0 or 6, or if the LTE UL/DL configuration is 1 and the special subframe configuration is 0 or 5; or if the parameter p-maxUE-FR1-r15 is provided and set to the maximum output power of the default power class or lower; the UE applies the requirements for the default power class and sets the configured transmitted power; else if the UE does not support a power class with higher maximum output power than PC2; or if the LTE UL/DL configuration is not 2 or 4 or 5; or if the field of UE capability maxUplinkDutyCycle-PC2-FR1 is absent and the percentage of UL symbols transmitted in a certain evaluation period is larger than 25%, or if the maxUplinkDutyCycle-PC2-FR1 is not absent and the percentage of UL symbols transmitted in a certain evaluation period is larger than 0.5*maxUplinkDutyCycle-PC2-FR1; or if the UE P-Max is provided and set to the maximum output power of the power class 2 or lower; the UE applies requirements for the power class 2 and sets the configured transmitted power; else the UE applies requirements for the supported power class and sets the configured transmitted power class as further specified in REFS7-9.

In one example for a FR1 PC2 UE and inter-band EN-DC within FR1 operation, if a UE supports a different power class than the default UE power class for an LTE TDD and NR TDD inter-band EN-DC band combination and the supported power class enables higher maximum output power than that of the default power class: if the field of UE capability maxUplinkDutyCycle-interBandENDC-TDD-PC2-r16 is absent and the percentage of NR UL symbols transmitted in a certain evaluation period is larger than 30%, or if the field of UE capability maxUplinkDutyCycle-interBandENDC-TDD-PC2-r16 is not absent and the percentage of NR UL symbols transmitted in a certain evaluation period is larger than maxUplinkDutyCycle-interBandENDC-TDD-PC2-r16, or if the E p-maxUE-FR1 is provided and set to the maximum output power of the default power class or lower, the UE applies requirements for the default power class to the supported power class and sets the configured transmitted power; else if the IE p-maxUE-FR1 is not provided or set to the higher value than the maximum output power of the default power class and the percentage of NR UL symbols transmitted in a certain evaluation period is less than or equal to maxUplinkDutyCycle-interBandENDC-TDD-PC2-r16, or if the IE p-maxUE-FR1 is not provided or set to the higher value than the maximum output power of the default power class and the percentage of NR UL symbols transmitted in a certain evaluation period is less than or equal to 30% when maxUplinkDutyCycle-interBandENDC-TDD-PC2-r16 is absent, the UE applies requirements for the supported power class and sets the configured transmitted power class as specified in REFS7-9.

In another example for a FR1 PC2 UE and inter-band EN-DC within FR1 operation, if a UE supports a different power class than the default UE power class for an E-UTRA FDD and NR TDD EN-DC band combination and the supported power class enables higher maximum output power than that of the default power class; if the UE indicates the two capabilities maxUplinkDutyCycle-FDD-TDD-EN-DC1 and maxUplinkDutyCycle-FDD-TDD-EN-DC2: if the IE p-maxUE-FR1 is not provided or set to the higher value than the maximum output power of the default power class, and the percentage of LTE UL symbols transmitted in a certain evaluation period is between 40% and 70%, and the percentage of NR UL symbols transmitted in a certain evaluation period is less than or equal to maxUplinkDutyCycle-FDD-TDD-EN-DC1, or if the IE p-maxUE-FR1 is not provided or set to the higher value than the maximum output power of the default power class, and the percentage of LTE UL symbols transmitted in a certain evaluation period is no larger than 40%, and the percentage of NR UL symbols transmitted in a certain evaluation period is less than or equal to maxUplinkDutyCycle-FDD-TDD-EN-DC2, the UE applies requirements for the supported power class and sets the configured transmitted power class; else the UE applies requirements for the default power class and set the configured transmitted power; else the UE applies requirements for the supported power class and sets the configured transmitted power as specified in REFS7-9.

In one example for a FR1 PC2 UE and inter-band carrier aggregation within FR1 operation, if a UE supports a different power class than the default UE power class for the band combination and the supported power class enables the higher maximum output power than that of the default power class; if the field of UE capability maxUplinkDutyCycle-interBandCA-PC2 is not absent and the average percentage of UL symbols transmitted in a certain evaluation period is larger than maxUplinkDutyCycle-interBandCA-PC2, or if 10 log 10 Σ p_{EMAX,c} or P_{EMAX,CA} is 23 dBm or lower; the UE applies requirements for the default power class to the supported power class and sets the configured transmitted power; else the UE applies requirements for the supported power class and set the configured transmitted power (regardless of the average percentage of UL symbols if the field of UE capability maxUplinkDutyCycle-interBandCA-PC2 is absent). The average percentage of UL symbols is defined as 50%×(Duty_{NR, x}/maxDuty_{NR,x}+Duty_{NR, y}/maxDuty_{NR,y}) where Duty_{NR, x}, Duty_{NR, y} may represent the actual percentage of UL symbols transmitted in the same evaluation period for NR Band x and NR Band y, respectively; and where maxDuty_{NR,x}, maxDuty_{NR,y} may represent the field of UE capability maxUplinkDutyCycle-PC2-FR1 per band. For NR Band x or NR Band y, if the power class of one or both of the bands within the band combination is power class 2 and the corresponding UE capability maxUplinkDutyCycle-PC2-FR1 is absent; the corresponding maxDuty_{NR,x} or maxDuty_{NR,y} is equal to 50%; else if the band is configured with power class 3; the corresponding maxDuty_{NR,x} or maxDuty_{NR,y} is equal to 100%.

For example, MPR based mitigation behavior may be used by the UE in conjunction with a maximum UL duty cycle to reduce a UE maximum output power as defined in REFS7-9. The UE may indicate or report a parameter maxUplinkDutyCycle-FR2 to the gNB, or a default value for the associated maximum UL duty may be assumed, wherein maxUplinkDutyCycle-FR2 is a UE capability to facilitate electromagnetic power density exposure requirements and may be associated with an FR2 power class.

In one example for a FR2 UE, if the field of UE capability maxUplinkDutyCycle-FR2 is present and the percentage of UL symbols transmitted including any PRACH transmission within any 1 sec evaluation period is larger than maxUplinkDutyCycle-FR2, the UE can follow the UL scheduling and can apply P-MPR_{c}. If the field of UE capability maxUplinkDutyCycle-FR2 is absent, the compliance to electromagnetic power density exposure requirements may be ensured by the UE by means of scaling down the power density or by other means, as further specified in REFS7-9.

An UL duty cycle is described in a UE maximum transmit power section and a configured transmitted power section as defined in REF7. When related to PCF behavior, then the UL duty cycle is captured in the UE maximum transmit power section noting that PCF behavior only applies to NR FR1. When related to MPR based mitigation (or for other reasons), then the UL duty cycle is captured in the configured transmitted power section. Any other (than UL duty cycle related) UE maximum power reduction conditions may be excluded here. For example, RRC IE P-Max to decide on use of higher supported or default PC or, in another example, any (CA) PEMAX or PUMAX related up/down configured Tx power adjustments may be excluded. FR1 Cases 1, 2a/b, 3 are based on 38.101-1 for PCF behavior, which may not be applicable for UL MIMO, V2X REDCAP, ATG, Aerial, etc. FR2 Cases 4, 5 are based on 38.101-2 for P-MPR, which may not be applicable for UL MIMO, Multiple Directions, etc. FR1 and/or FR2 LTE and/or NR Case 6 based on 38.101-3. Examples use PC1/5/2 behavior because FR1 PC1 is not targeted for smartphone form factor but for public safety.

The term “max UL duty cycle” may refer to the reported UE capability, e.g., maxUplinkDutyCycle-PC2-FR1. The term “UL duty cycle” may refer to the “actual” or “observed” UL usage ratio as evaluated during system operation.

In one scenario, for FR1 single NR carrier: Single UL duty cycle, the UE determines the single UL duty cycle as “percentage of UL symbols transmitted during a certain evaluation period”.

| | |
|---|---|
| | If the UE supports PC1.5 or PC2 |
| ∘ | IF |
| | - (No UE cap for max UL duty cycle with PC1.5/2 and UL duty cycle > 50%) OR |
| | - (UE cap for max UL duty cycle with PC2 and UL duty cycle > max) OR |
| | - (UE cap for max UL duty cycle with PC1.5 and UL duty cycle > ½*max) |
| ∘ | THEN |
| | - apply default PC3 |
| ∘ | ELSEIF |
| | - (UE only supports PC2) OR |
| | - (No UE cap for max UL duty cycle with PC1.5/2 and UL duty cycle > 25%) OR |
| | - (UE cap for max UL duty cycle with PC2 and UL duty cycle > ½*max) OR |
| | - (UE cap for max UL duty cycle with PC1.5 and UL duty cycle > max) |
| ∘ | THEN |
| | - apply default PC2 |
| ∘ | ELSE |
| | - apply the supported PC, i.e., PC1.5 or PC2 |

In another scenario, for FR1 intra-band contiguous or non-contiguous CA: Single (effective) UL duty cycle, the UE determines single (effective) UL duty cycle as “percentage of total UL symbols transmitted on all UL CCs” noting that above PC2 for CA may not currently be defined and noting that implementation could use single count loop or separate count loops per CC followed by symbol matching.

If the UE supports PC2

| | |
|---|---|
| ∘ | IF |
| | - (UE cap for max UL duty cycle with PC2 and UL duty cycle > max) |
| ∘ | THEN |
| | - apply default PC3 |
| ∘ | ELSE |
| | - apply the supported PC, i.e., PC2 |

In another scenario, for FR1 inter-band CA or SUL: Single average UL duty cycle (based two separate UL duty cycles), the UE determines single average UL duty cycle as “average percentage of UL symbols defined as 50%×(Duty_{NR, x}/maxDuty_{NR,x}+Duty_{NR, y}/maxDuty_{NR,y}) where Duty_{NR, x}, Duty_{NR, y} represent the actual percentage of UL symbols transmitted in the same evaluation period for NR Band x and NR Band y, respectively; and where maxDuty_{NR,x}, maxDuty_{NR,y} represent the field of UE capability maxUplinkDutyCycle-PC2-FR1 per band. Default values for maxDuty_{NR,x} or maxDuty_{NR,y} is 50% for PC2; else the corresponding maxDuty_{NR,x} or maxDuty_{NR,y} is 100% for the default PC3.” PC2 for CA may not currently be defined.

If the UE supports PC2

| | | |
|---|---|---|
| ∘ | IF | |
| | - | (UE cap for max UL duty cycle with PC2 and average UL duty cycle > max) |
| ∘ | THEN | |
| | - | apply default PC3 |
| ∘ | ELSE | |
| | - | apply the supported PC, i.e., PC2, even when no UE cap for max UL duty cycle |
| | | with PC2 and regardless of average UL duty cycle. |

In another scenario, for FR1 NR-DC: UL duty cycle counting/determination is currently not applicable. The reason is that greater than a default PC3 may not currently be defined for NR-DC band combinations (BCs).

In another scenario, for FR2 single NR carrier: single UL duty cycle, the UE determines the single UL duty cycle as “percentage of UL symbols transmitted during a certain evaluation period”.

| | |
|---|---|
| ∘ | IF |
| | - (UE cap for max UL duty cycle and UL duty cycle > max) |
| ∘ | THEN |
| | - UE follows UL scheduling and can apply P-MPR |
| ∘ | ELSE |
| | - UE can scale down the PSD or apply other means |

In another scenario, for FR2 intra-band or inter-band CA: UL duty cycle may not currently be applicable. The reason for this is that no separate MPR-based MPE mitigation behavior may be specified (with respect to single carrier behavior).

In another scenario, for all other cases such as FR1 intra-band contiguous or non-contiguous EN-DC/NE-DC, inter-band EN-DC/EN-DC within FR1: single UL duty cycle, the UE determines the single UL duty cycle as “percentage of UL symbols transmitted during a certain evaluation period”. This usually involves different/separate UE capability parameters for the variety of CA or DC combinations involving LTE. This usually is different, e.g., often smaller than Case 1 or 2a/b, default values for max UL duty cycle if not indicated/reported by the UE.

In general, for NR FR1 or FR2 single carrier operation, the UE determines a “single UL duty cycle.” For NR-NR FR1 intra-band CA and inter-band CA operation (“intra-RAT”), an existing notion of a “single (effective) UL duty cycle across the UL carriers which is then implicitly derived by the UE implementation such as based on per-CC counting (for intra-band CA) and an existing notion of an explicitly defined as “equal weight average metric based on the 2 per-CC UL duty cycles” (for NR-NR inter-band or NUL/SUL). For the large variety of NR-NR, LTE-NR, or LTE-NR DC combinations (“inter-RAT”), within FR1, within FR2, across FR1-FR2, either no notion of UL duty cycle exists, or single UL duty cycle (per SpCell) is used.

With reference to detailed NR UL transmit power control procedures according to Rel-15 NR, a UE determines an UL transmission power for PUSCH, PUCCH, SRS, and PRACH transmissions.

Using Rel-15 NR, the NR UL transmit power control is based on a combination of open-loop power control (OLPC) and closed-loop power control (CLPC) components. OLPC includes support for fractional pathloss compensation where the UE estimates a pathloss to a serving gNB, based on measurements for DL signals/channels from the serving gNB, and accordingly adjusts a transmission power. CLPC is based on transmit power control (TPC) commands provided by the gNB where, for example, the gNB may determine values for the TPC commands to the UE based on measurements of the received power for transmissions from the UE. The NR UL power control procedure also supports beam-based power control.

If a UE transmits a PUSCH on active UL BWP b of carrier f of serving cell c using parameter set configuration with index j and PUSCH power control adjustment state with index l, the UE determines the PUSCH transmission power P_{PUSCH,b,f,c}(i,j,q_{d},l) in dBm in PUSCH transmission occasion i as,

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i . l )\end{matrix}\end{matrix} \}$$

P_{CMAX}(.) is the configured maximum UE output power per carrier. P₀(.) corresponds to a normalized target received power level that may be indicated by a serving gNB using one or multiple signaled higher layer parameters. PL(.) corresponds to a pathloss estimate by the UE, for example based on an SSB or a NZP CSI-RS. α(.) is a parameter for fractional pathloss compensation that is indicated by the serving gNB. M_{RB}(.) corresponds to the number of RBs for the PUSCH transmission when adjusting a normalized (per RB and 15 kHz SCS) target receive power. Δ_{TF}(.) may be associated with a modulation scheme and channel-coding rate used for the data information provided by the PUSCH transmission and can be viewed as modeling link capacity such as 80% of Shannon capacity. This term may not be included when determining a PUSCH transmit power and can be applicable only for single-layer UL transmissions. f(.) corresponds to a power adjustment state due to the CLPC component.

The configured maximum output power P_{CMAX,f,c} accounts for the UE power class, a maximum power reduction such as MPR, A-MPR, and/or P-MPR, and is set within the following bounds as described in REFS. 7-9:

$${P}_{CMAX \_ L , f , c} \leq {P}_{CMAX , f , c} \leq {P}_{CMAX \_ H , f , c} with$$

$${P}_{CMAX \_ L , f , c} = MIN \{ {P}_{EMAX , c} - Δ {T}_{C , c} , ( {P}_{P o w e r C l a s s} - Δ {P}_{P o w e r C l a s s} ) - MAX ( MAX ( MP {R}_{c} + Δ MP {R}_{c} , A - {MPR}_{c} ) + Δ {T}_{I B , c} + Δ {T}_{C , c} + Δ {T}_{R x S R S} , P - M P {R}_{c} ) \} and$$

$${P}_{CMAX \_ H , f , c} = MIN \{ {P}_{E M A X , c} , {P}_{PowerClass} - Δ {P}_{P o w e r C l a s s} .$$

Here, P_{EMAX,c} is provided by higher layer provided parameter p-Max or by the field additionalPmax of the higher layer parameter NR-NS-PmaxList, as described in REF6. P_{PowerClass} is the maximum UE power of the applicable UE power class specified in REFS7-9 without taking into account the tolerances specified in REFS7-9. The parameter p-Max (range from −30 . . . 33) is used to limit the UE's transmission power on a carrier frequency and may also be used for the UE to calculate compensation factors during cell (re-)selection in RRC_IDLE and/or RRC_INACTIVE states. p-Max is the maximum transmit power allowed in a serving cell with value in dBm.

In addition to limiting a UE transmit power on a serving cell, a total UE transmit power over serving cells for the UE may also be limited. Such a limitation of the UE transmit power over multiple UL carriers may also apply in case of LTE/NR dual connectivity. For example, a maximum transmit power that the UE may use on a serving cell may then be additionally limited by parameters p-NR-FR1 configured for the cell group and p-UE-FR1 configured total power for serving cells operating on FR1. If absent, the UE applies the maximum power according to REFS7-9 in case of an FR1 cell or an FR2 cell. Further details are described in REFS7-9.

The sum P₀(.)+α(.) PL(.) is associated with OLPC and, for α(.)<1, it includes fractional pathloss compensation. For full pathloss compensation (α(.)=1), OLPC adjusts the PUSCH transmit power such that the received power aligns with the target received power P₀(.). For example, P₀(.) may be selected and indicated by the gNB to the UE depending on the target data rate and/or the noise and interference level experienced at the gNB receiver for the UE. For fractional pathloss compensation (α(.)<1), pathloss is not fully compensated while interference to neighbor cells is reduced. The gNB received power for transmissions from a UE may, on average, vary depending on the UE location within the serving cell. For example, for partial pathloss compensation, PUSCH transmissions from UEs experiencing larger pathloss, due to being at larger distances from the gNB, may be received by the gNB with lower power that PUSCH transmissions from UEs experiencing smaller pathloss. The gNB may compensate by adjusting the UL data rate of UEs accordingly and operate UEs located closer to the gNB with larger data rates than UEs located further from the gNB. In consequence, there may be larger variations in the service quality and reduced data rate availability for UEs further from the gNB (closer to the cell border) when using fractional pathloss compensation.

NR UL transmit power control procedures support beam-based power control. For example, a UE can be configured multiple DL reference signals for pathloss measurements, multiple OLPC parameter sets, and multiple CLPC processes.

In the case of beamforming, a pathloss estimate PL(.) that a UE uses to determine a transmit power should reflect the path loss, including the beamforming gains, of the paired UL beam that the UE uses to transmit a PUSCH. When DL/UL beam correspondence is assumed, the UE can estimate the pathloss based on measurements for a DL reference signal that is transmitted by the gNB over the corresponding paired DL beam. As the UL beam used for UL/DL beam pair may change across PUSCH transmissions, the UE may need to maintain multiple pathloss estimates corresponding to different candidate UL/DL beam pairs. The gNB can configure the UE with a set, such as up to 4, of DL reference signals for pathloss measurements, such as SSBs and/or NZP CSI-RSs. The gNB can also configure a mapping among SRS resource indicator (SRI) values and pathloss DL reference signals. A DCI format scheduling a PUSCH transmission can include a SRI field indicating one of the SRI values and the UE uses a pathloss estimate obtained from the DL RS associated with the indicated SRI value to determine a pathloss value to apply for the determination of the transmit power for the PUSCH transmission.

A UE can be configured multiple, such as up to 30, OLPC parameter sets {P₀(.), α(.)}, each corresponding to a pair of values for a normalized target receive power level and a fractional pathloss compensation coefficient. A UE may use parameter pair {P₀(1), α(1)} for PUSCH transmissions associated with configured grants while remaining parameter pairs are associated with PUSCH transmissions scheduled by DCI formats. The gNB may associate each value of the SRI field in a DCI format with one of the indicated OLPC parameter set pairs. For example, the gNB may select and indicate an OLPC parameter set using separate values for normalized target receive power level and fractional pathloss compensation coefficient, respectively, for each UL beam that can be used by the UE to transmit a PUSCH. For a PUSCH transmission before the UE receives dedicated configuration for OLPC parameters, such as for a Msg3 PUSCH transmission or for a PUSCH transmission scheduled by a DCI format with CRC scrambled by a temporary C-RNTI (TC-RNTI), fractional power control is not used, e.g., α(.)=1, and P₀(.) may be determined by the UE based on received information in the configuration of the random-access procedure.

With respect to multiple OLPC parameter sets, NR supports for a UE (e.g., the UE 116) to be configured with up to three values for the normalized target receive power P₀(.) resulting to up to three respective values for a PUSCH transmit power. A DCI format scheduling the PUSCH transmission can indicate one of the P₀(.) values for the UE to use in determining a power for the PUSCH transmission. For example, a DCI format 0_1 or a DCI format 0_2 may be configured to include a OLPC parameter set indication field and its associated index values are indicated by higher layer signaling such parameter P0-PUSCH-Set-r16 as described in REF2 and REF6. The OLPC parameter set indication field has length of 1 bit when the DCI format scheduling the PUSCH transmission also includes the SRI field and has length of 1 bit or 2 bits when the SRI field is not present. It is noted that the OLPC parameter set indication field indicates only the normalized target receive power setting P0(.) and does not indicate the fractional pathloss coefficient α(.).

A UE can be configured with two SRS resource sets. Values of two SRS resource set indicator fields in a DCI format scheduling a PUSCH transmission can indicate a first and a second normalized target receive power P₀(.) from a first and a second OLPC parameter set p0-PUSCH-Alpha and p0-PUSCH-Alpha2, respectively, that is provided by higher layers. Determination of the target receive power and fractional pathloss compensation coefficient by the UE is per SRI field as in the case of a single SRI field in the DCI format.

Furthermore, the UE can be configured with multiple, such as 2, independent CLPC processes. Similar to having multiple pathloss DL reference signals and multiple OLPC parameter sets, the selection of the associated CLPC process by the UE can be configured by higher layers for the SRI value indicated by the DCI format.

The corresponding UL transmit power procedures for the cases of other UL channels or signals such as PUCCH, SRS or PRACH are further described in REF3.

With reference to detailed 5G/NR procedures for single cell operation with two uplink carriers or for operation with carrier aggregation or for operation with a candidate cell configured by LTM-Config, if a total UE transmit power for PUSCH or PUCCH or PRACH or SRS transmissions on serving cells or on a candidate cell, if any, in a frequency range in a respective transmission occasion i would exceed \hat{P}_{CMAX}(i), where \hat{P}_{CMAX}(i) is the linear value of P_{CMAX}(i) in transmission occasion i as defined in REFS7-9, the UE allocates power to PUSCH/PUCCH/PRACH/SRS transmissions according to a certain priority order so that the total UE transmit power for transmissions on serving cells or on a candidate cell, if any, in the frequency range is smaller than or equal to \hat{P}_{CMAX}(i) for that frequency range in every symbol of transmission occasion i.

A descending priority order from higher to lower priority is defined by system operating specifications in REF3 according to: (1) a PRACH transmission on a candidate cell; (2) a PRACH transmission on the PCell; (3) PUCCH or PUSCH transmissions with larger priority index; (4) for PUCCH or PUSCH transmissions with same priority index a PUCCH transmission with HARQ-ACK information, and/or SR, and/or LRR, or a PUSCH transmission with HARQ-ACK information of the priority index, PUCCH or PUSCH transmission with CSI, PUSCH transmission without HARQ-ACK information of the priority index or CSI and, for Type-2 random access procedure, PUSCH transmission on the PCell; (5) if the UE is configured with a parameter prioSCellPRACH-OverSP-PeriodicSRS-r17, aperiodic SRS transmission or PRACH transmission on a serving cell other than the PCell, semi-persistent and/or periodic SRS transmission; and (6) otherwise an SRS transmission, with aperiodic SRS having higher priority than semi-persistent and/or periodic SRS, or a PRACH transmission on a serving cell other than the PCell.

In case of same priority order and for operation with carrier aggregation, the UE may prioritize power allocation for transmissions on the primary cell of the MCG or the SCG over transmissions on a secondary cell. In case of same priority order and for operation with two UL carriers, the UE may prioritize power allocation for transmissions on the carrier where the UE is configured to transmit PUCCH. If PUCCH is not configured for any of the two UL carriers, the UE may prioritize power allocation for transmissions on the non-supplementary UL carrier. Further details are described in REF3.

With reference to detailed 5G/NR procedures for dual connectivity operation, the UE may be configured with a maximum transmission power for transmissions on an MCG or an SCG wherein the MCG or the SCG may operate according to 4G/LTE or to 5G/NR.

For example, if a UE is configured with an MCG using LTE radio access and with an SCG using NR radio access, i.e., EN-DC operation or LTE-NR dual connectivity operation, the UE is configured a maximum power P_{LTE} for transmissions on the MCG by parameter p-MaxEUTRA and a maximum power P_{NR} for transmissions in FR1 on the SCG by p-NR-FR1. The UE determines a transmission power for the MCG according to REF9 using P_{LTE} as the maximum transmission power. The UE determines a transmission power for the SCG in FR1 or FR2 as described in REF3 using P_{NR} as the maximum transmission power. Certain limitations may apply with respect to an LTE configuration. For example, the UE does not expect to be configured for operation with the LTE shortened TTI and/or processing time features on a cell that is included in an EN-DC configuration.

If a UE is configured with

$${\hat{P}}_{L T B} + {\hat{P}}_{N R} > {\hat{P}}_{T otal}^{EN - D C} ,$$

where \hat{P}_{LTE} is the linear value of P_{LTE}, \hat{P}_{NR} is the linear value of P_{NR}, and

$${\hat{P}}_{T otal}^{EN - D C}$$

is the linear value of a configured maximum transmission power for EN-DC operation as defined in REFS7-9, the UE may determine a transmission power for the SCG as follows. Note that if the UE does not indicate a capability for dynamic power sharing between LTE and NR for EN-DC, the UE expects to be configured with a reference TDD configuration for 4G/LTE by parameter tdm-PatternConfig according to REF9.

If the UE is configured with a reference TDD configuration for LTE by a parameter tdm-PatternConfig or by tdm-PatternConfig2 in REF9: if the UE does not indicate a capability for dynamic power sharing between LTE and NR for EN-DC, the UE does not transmit in a slot on the SCG in FR1 when a corresponding subframe on the MCG is an UL subframe in the reference TDD configuration; if the UE indicates a capability for dynamic power sharing between E-UTRA and NR for EN-DC, and does not indicate a capability tdm-restrictionDualTX-FDD-endc-r16, and is configured with tdm-PatternConfig2, the UE does not transmit on the SCG in FR1 when the UE has overlapped transmission on a subframe on the MCG.

If the UE indicates a capability for dynamic power sharing between LTE and NR for EN-DC and if UE transmission(s) in subframe i₁ of the MCG overlap in time with UE transmission(s) in slot i₂ of the SCG in FR1, and if

$${\hat{P}}_{M C G} ( {i}_{1} ) + {\hat{P}}_{S C G} ( {i}_{2} ) > {\hat{P}}_{Total}^{EN - DC}$$

in any portion of slot i₂ of the SCG, the UE reduces transmission power in any portion of slot i₂ of the SCG so that

$${\hat{P}}_{M C G} ( {i}_{1} ) + {\hat{P}}_{S C G} ( {i}_{2} ) \leq {\hat{P}}_{T otal}^{EN - D C}$$

in any portion of slot i₂, where \hat{P}_{MCG}(i₁) and \hat{P}_{SCG}(i₂) are the linear values of the total UE transmission powers in subframe i₁ of the MCG and in slot i₂ of the SCG in FR1, respectively. The UE is not required to transmit in any portion of slot i₂ of the SCG if \hat{P}_{SCG}(i₂) would need to be reduced by more than the value provided by X_{SCALE} in order for

$${\hat{P}}_{M C G} ( {i}_{1} ) + {\hat{P}}_{S C G} ( {i}_{2} ) \leq {\hat{P}}_{T otal}^{EN - D C}$$

in any portion of slot i₂ of the SCG. The UE is required to transmit in slot i₂ of the SCG if \hat{P}_{SCG}(i₂) would not need to be reduced by more than the value provided by X_{SCALE} in order for

$${\hat{P}}_{M C G} ( {i}_{1} ) + {\hat{P}}_{S C G} ( {i}_{2} ) \leq {\hat{P}}_{T otal}^{EN - D C}$$

in all portions of slot i₂.

Further details for the case of NE-DC operation, i.e., NR-LTE dual connectivity operation, or for the case of NR-DC operation, i.e., NR-NR dual connectivity operation, are defined in REF3.

Using dual active protocol stack (DAPS) operation, a UE can maintain two independent radio protocol stacks simultaneously. Which parts of a user-plane radio protocol stack, i.e., a protocol layer such as L1/PHY, or MAC, or RLC, or PDCP, need to be maintained by the UE independently, and if there is additional need to independently maintain a control-plane radio protocol, i.e., a protocol layer such as RRC or MM, can depend on the DAPS operational scenario.

For example, when using 5G/NR, a user plane radio protocol stack for radio access may comprise a protocol functionality such as L1/PHY, or MAC, or RLC, or PDCP, or SDAP. For example, when using 5G/NR, a control plane radio protocol stack for radio access may comprise a protocol functionality such as RRC, or a non-access stratum (NAS) protocol. For example, a NAS protocol may correspond to a functionality such as a mobility management (MM) protocol between the UE and an Access and Mobility Management Function (AMF) in the Core Network or a session management protocol between the UE and a User Plane Function (UPF). Signaling or messages corresponding to a control plane radio protocol may be carried by a user plane protocol. For example, an RRC message or signaling may be carried in a PDCP, or RLC, or MAC SDU or PDU or in a L1/PHY transport block (TB). For example, a NAS protocol between AMF and UE (or vice-versa) may be carried in an RRC message or by RRC signaling.

For example, DAPS operation in 4G/LTE or 5G/NR in a L3 handover procedure can enable reduced delays and/or reduced interruption time during handover or mobility events. Independent radio protocol stacks with respect to a source cell and a target cell, respectively, apply at least with respect to L1/PHY, MAC, and RLC. For example, DAPS operation between 5G/NR and 6G or between 4G/LTE and 6G, respectively, can enable a smooth transition between the different network generations or radio access technologies. Independent radio protocol stacks for simultaneous connectivity using two radio access technologies (RATs) from the UE to the network, may apply with respect to the user plane radio protocol stack, i.e., L1/PHY, MAC, RLC, PDCP and with respect to a separate control plane protocol such as RRC or MM for the first and the second radio-access technology (RAT), respectively.

In one example, DAPS operation with reference to L3 based mobility handling in 5G/NR is considered. DAPS handover is a handover procedure wherein the UE maintains the source gNB connection after reception of RRC message for handover and until releasing the source cell after successful random access to the target gNB. Only source and target PCell are used during a DAPS handover. Other configurations provided to the UE such as carrier-aggregation (CA), or dual connectivity (DC), or supplemental UL (SUL), or multi-TRP, or conditional handover (CHO), or user plane data compression (UDC), or L1-triggered mobility (LTM), are released by the source gNB before the handover command is sent to the UE and are not configured by the target gNB until the DAPS handover has completed, i.e. at earliest in the same message that releases the source PCell. For example, DAPS handover is not supported for the case of FR2 to FR2 handover. From the UE perspective the support of at least dual Rx chains may be required, and the support of dual Tx chains may depend on the DAPS operational scenario, e.g., intra-frequency or inter-frequency handover scenario, synchronous or asynchronous deployment scenario, a reception bandwidth for a target and source being a same or different, etc.

Upon receiving a handover command requesting DAPS handover, the UE creates, i.e., instantiates, a separate MAC entity for the target gNB, establishes a separate RLC entity and an associated DTCH logical channel for the target gNB for each DRB configured with DAPS, and for each DRB configured with DAPS, reconfigures the PDCP entity with separate security and ROHC functions for source gNB and target gNB and associates them with the RLC entities configured by source gNB and target gNB, respectively, and the UE retains the rest of the source configurations until release of the source gNB.

Upon receiving a handover command requesting DAPS handover, the UE suspends source cell/gNB SRBs, stops sending and receiving any RRC control plane signaling toward the source cell/gNB, and establishes SRBs for the target cell. The UE releases the source cell SRBs configuration upon receiving source cell/gNB release indication from the target cell/gNB after successful DAPS handover execution. When DAPS handover to the target cell/gNB fails and if the source cell/gNB link is available, then the UE reverts back to the source cell/gNB configuration and resumes source cell/gNB SRBs for control plane signaling transmission, e.g., the UE may report DAPS handover failure via the source cell/gNB without triggering RRC connection re-establishment if the source cell/gNB link has not been released.

For DRBs configured with DAPS in the case of intra-NR handover, i.e., 5GC is not involved, the source gNB does not stop delivering uplink QoS flows to the UPF until it sends the SN STATUS TRANSFER message. The target gNB does not forward QoS flows of the UL PDCP SDUs successfully received in-sequence to the UPF until it receives the SN STATUS TRANSFER message, in which UL HFN and the first missing SN in the uplink PDCP SN receiver status indicates the start of UL PDCP SDUs to be delivered to the UPF. The target gNB does not deliver any UL PDCP SDUs which has an UL COUNT lower than provided.

For brevity of description, other aspects of DAPS operation such as network internal operation, according to existing 5G/NR specifications are omitted from this example. More detailed aspects are defined in system operating specifications such as REF10. Similar considerations related to separate or independent user plane protocols maintained by the UE in a DAPS handover with respect to a source and target can be applied to the case of 4G/LTE.

In one example, DAPS operation between 5G/NR and 6G is considered. For example, DAPS operation may be supported by the UE based on a single (e)SIM and a dual subscription. For example, DAPS operation may be supported based on separate or multiple (e)SIMs, i.e., dual (e)SIM operation, and a subscription associated with an (e)SIM, respectively.

For the example of a single (e)SIM and dual subscription, or Single SIM dual-subscription (SSDS) operation, dual-active protocol operation (DAPS) can allow a UE to establish and/or maintain simultaneous connectivity with respect to a first radio access technology (RAT) such as 5G/NR and with respect to a second RAT such as 6G on the operator network based on profiles associated with the (e)SIM. A single (e)SIM may contain multiple profiles or multiple subscriptions. Using SSDS operation, associated RAT(s) can be provided for a PMLN or SNPN. For example, a first profile may provide information to the UE on network access or connectivity for a first RAT, e.g., 5G/NR, and a second profile for a second RAT, e.g., 6G. For example, the UE may switch between these profiles or subscriptions and select one of the first RAT or the second RAT for purposes such as cell selection or cell re-selection. For example, the UE may use the profiles or subscriptions and the associated first and second RATs to establish or maintain concurrent connectivity to a network, e.g., the UE may be connected to a cell using the first RAT in a first band, while being connected to a cell using the second RAT in a second band. In the example, each profile or subscription may operate independently with its own radio protocol stack. A dual-active protocol stack can allow that a profile or a subscription corresponding to the first and the second RAT, respectively, remains concurrently or simultaneously active. DAPS operation or multiple profiles or subscriptions may allow to the UE to handle a call or a data transmission or reception from either profile or subscription independently without needing to switch between them.

For example, based on DAPS operation, the UE may be concurrently connected to a 5G/NR cell using the NR L1, MAC, RLC, PDCP user plane radio protocol stack on a first carrier in a first band while being connected to a 6G cell using a 6G L1, MAC, RLC, PDCP user plane radio protocol stack on second carrier in a second band. For example, the UE may connect to the 5G CN and in 5GMM-REGISTERED state following a control plane signaling exchange with the AMF in the core network while being connected to the 6G CN and in 6GMM-REGISTERED state. For example, the UE may be connected to the 5G radio access network (RAN) and in 5G/NR RRC_CONNECTED mode following an RRC control plane signaling exchange with the network while being connected to the 6G RAN in 6G RRC_IDLE mode. For example, parts or all of a 5G or 6G RAN or of a 5G or 6G RAN may be shared functions.

Without loss of generality, the examples can be extended to other cellular communication protocols, or to other combinations of a first RAT and a second RAT, respectively, such as DAPS operation based on 4G/LTE and 6G, or to other cases of radio transmission and reception such as when the first and the second RAT may use a same carrier in the band or different carriers in a same band.

When considering UE procedures for UE transmitter power and UL transmit power control for operation in wireless communications systems, several issues related to limitations and drawbacks of existing technology need to be overcome in order to increase the UE communications range, or to increase the UE data throughput rate, or to improve system operation according to channel conditions.

It needs to be considered that for receptions in the UL by a gNB in a network deployment supporting one or more RATs in one or more bands, a different number of receiver antennas or panels, a different effective receive antenna aperture area, or a different receive antenna directivity setting may be available for receptions in a first band corresponding to the first RAT, e.g., 6G radio access, and for receptions in the second band corresponding to the second RAT, e.g., 5G/NR radio access, when compared to receptions in a same band. An antenna or panel configuration in either or both bands at the gNB may not be known to a UE. Similar considerations may be applied with respect to transmissions in the DL from the gNB.

For example, the network deployment may support a 16 TRX panel with 64 antenna elements in a panel in an FR1 band such as n3/n7 for 5G/NR radio access, or may support a 64 TRX panel with 128 antenna elements in a panel in an FR1 band such as n77/78 for 5G/NR radio access, or may support a 256 TRX panel with 768 antenna elements in a panel in an FR3 band such as 7-8 GHz for 6G radio access.

Furthermore, the processing gain and a corresponding received signal-to-noise/interference ratio of an UL signal/channel may not be the same for receptions in the first and the second RATs, respectively. It can be expected that 6G radio access can improve upon the demodulation and multiplexing performance of 5G/NR radio access due to aspects such as advances in signal/channel design, or multiplexing, or channel coding, or beamforming, or multiple-antenna operation, or modem processing, or AI/ML.

It needs to be considered that a network loading and the corresponding interference levels experienced by the gNB receiver may differ between receptions in the first band corresponding to the first RAT, e.g., 5G/NR radio access, and the second band corresponding to the second RAT, e.g., 6G radio access, respectively.

For example, it may be expected that a network loading in FR1 bands such as n1, or n3 or n7 in 2 GHz bands using 5G/NR radio access is initially higher than a network loading in an FR3 band such as 7-8 GHz. A factor is an initially expected low penetration or availability rate of UEs supporting 6G radio access and a continued use of 5G/NR radio access in the 5G/NR bands of the deployment. For example, it can be expected, that network loading and corresponding interference levels experienced by the gNB receiver in the second band corresponding to 6G radio access may increase over time as penetration rate or availability of 6G capable UEs increase. For example, it can be expected that network loading and corresponding interference levels in the 5G/NR band and the 6G band, respectively, may vary depending on network processing capabilities and operator deployment considerations.

Therefore, the resulting signal reception and/or interference power levels and their variation experienced by the gNB receiver may not be same for reception of a signal/channel in the first band corresponding to the first RAT when compared to reception of the signal/channel in the second band corresponding to the second RAT. For example, a UE transmission power for UL transmissions from the UE may not be same for a signal/channel in the first band corresponding to the first RAT when compared to UL transmission by the UE of the same signal/channel in the second band corresponding to the second RAT even if a same receive operating SINR target value for UL reception in the first and the second band would apply.

Using existing technology, a first issue relates to a maximum UL duty cycle, or a UE power class fallback behavior, or an MPR based mitigation behavior according to the existing 4G/LTE or 5G/NR specifications, for example to ensure compliance with the applicable electromagnetic energy absorption requirements based on MPE requirements or unwanted emissions or self-de-sense requirements.

Using existing technology, an FR1 UE can support a different power class such as PC2 or PC 1.5 enabling a higher maximum output power than a default PC such as PC3 in a band for single carrier operation or for carrier aggregation or dual connectivity in a band combination. Note that for dual RAT mode based on dual connectivity, e.g., for EN-DC with 4G/LTE radio access on the PCG and 5G/NR radio access on the SCG, the UE can indicate or declare support for one EN-DC power class in a certain band combination. Similar principles apply to other dual connectivity cases such as NE-DC or NR-NR. Use of a higher than default maximum output power in a band can increase the UL coverage or the UL throughput of the UE. A higher supported maximum output power than enabled by the default PC may be employed by the UE if the number of UL symbols for UL transmissions in a period do not exceed a certain supported (or a default) maximum UL duty cycle.

In one example, a UE indicating or declaring support for PC2 for the inter-band EN-DC DC_3A-n78A (two-bands) band combination using existing technology is considered. 4G/LTE radio access is used for the FDD LTE band 3 (1800 MHz), and 5G/NR radio access is used for the TDD NR band 78 (3500 MHz). For example, a supported or a default maximum UL duty cycle for an indicated or supported UE power class may be expressed as the percentage X of UL symbols in a certain evaluation period. For example, X=50% for PC2. When the UE is configured or indicated for a number of UL transmissions in a period in the first band, i.e., using 4G/LTE, and exceeds the supported or default maximum UL duty cycle, the UE would then autonomously reduce its maximum output power in both the first band using 4G/LTE radio access and the second band using 5G/NR radio access in the band combination based on the existing UE power class fallback procedure. For example, a UE supporting EN-DC PC2, or 26 dBm, may then employ power-class fallback and accordingly reduce the UE maximum output power according to the default EN-DC PC3, or 23 dBm, for both the 4G/LTE band and the 5G/NR band.

It needs to be considered that 5G/NR and/or 4G/LTE define one combined UE power class for such FR1 carrier aggregation or dual connectivity band combinations in the existing technology. One reason for the single power class approach in the existing technology within a frequency range such as FR1 is a typically small available frequency separation across the span of the FR1 frequency range corresponding to the 5G/NR and/or 4G/LTE radio access in the inter-band carrier aggregation or dual connectivity band combination.

It needs to be considered that a notion of one combined UE power class for an FR1-FR2 carrier aggregation or dual connectivity band combination across frequency ranges such as FR1 and FR2 is not provided by existing state of the art. One reason is that an FR1 UE Power Class and an FR2 UE Power Class are defined very differently, i.e., a label or term “PC” does not allow to compare a Power Class between FR1 and FR2, respectively. An FR1 UE Power Class is defined generically with respect to a maximum output power independent of a device type, i.e., and usually targeting a smartphone form factor as by REF7. An exception is the FR1 UE PC1, or 31 dBm, which specifically targets and is applicable for public-safety scenarios operating in NR band 14 where corresponding special regulatory allowances and even higher UE maximum output power may apply. An FR2 UE Power Class is defined with respect to an EIRP/radiated power in FR2 and corresponds to a specific UE device type, or hardware, such as a Fixed Wireless Access UE or a Vehicular UE, or a Handheld UE, with a corresponding set of assumptions on a number, or a size, or a placement, or a characteristic of one or more antenna panels for a device type. Correspondingly, a notion of UE Power Class fallback behavior such as provided by existing state-of-the art in FR1 is currently not defined for FR2. A reason is that it is not considered meaningful to consider “fallback” from an FR2 device type such as FR2 PC1, or UE device type “Fixed Wireless Access”, to another FR2 device type such as a FR2 PC2, or a UE device type “Vehicular UE”, because the physical design assumptions may be different. In consequence, a notion of one combined UE power Class across FR1 and FR2 for a carrier aggregation or a dual connectivity band combination can then not be applied. An additional consideration is that an FR1-FR2 band combinations can be separated by a very wide frequency separation, such as 15 GHz or more, which may be implemented based on separate RF front-ends and antenna or antenna panel paths for FR1 and FR2, respectively. FR1 and FR2 transmissions or receptions can then often operate independently. In summary, existing technology doesn't provide solutions with respect to a UE power class fallback behavior, or an UL duty cycle evaluation, or an MPR based mitigation behavior, across frequency ranges such as across FR1 and FR2 for an FR1-FR2 band combination.

Using existing technology, the UE power class fallback behavior for 6G radio access in FR1 or FR3 would then be applied indiscriminately with respect to the first or the second band in a dual RAT band combination. When a maximum output power is reduced due to a higher UL duty cycle in the first band for the MCG, i.e., in a lower band using 5G/NR radio access, a maximum output power is then also correspondingly reduced for the second band for the SCG, i.e., in a higher band using 6G radio access. This is undesirable because the achievable UL coverage or UL throughput of the dual RAT UE supporting 6G radio access may then be accordingly reduced in the higher band using 6G radio access. A use of a same CA or DC power class for a band combination and a corresponding same power class fallback behavior by the UE is less motivated for FR1 and FR3 when considering the wider available frequency separation between an FR1 low-band or mid-band, e.g., for 5G/NR radio access, and an FR3 band such as 7-8 GHz, e.g., for 6G radio access, when compared to the existing FR1 band combinations for inter-band CA, or EN-DC DC, or NR-NR DC. A wider frequency separation between FR1 and the FR3 bands can reduce a need to employ a power reduction or maximum output power restrictions in a band to maintain an UL transmission signal quality or to reduce a DL demodulation performance degradation potentially arising from RF constraints such as 2^{nd} or 3^{rd} order intermodulation products. This can enable RF operation by the UE subjected to fewer constraints in FR1 and FR3, respectively. Similar considerations can be applied to other cases such as NR-NR dual-connectivity or dual-active protocol stack operation for dual RAT UEs supporting 5G/NR and 6G radio access in FR1 and FR3, respectively.

Using existing technology, a second issue relates to the gNB scheduling and reduced spectral efficiency during system operation. The gNB may not become instantly aware of when and why and under which conditions a UE applies a power class fallback or MPR based mitigation behavior in the network deployment with 6G.

For example, the gNB may attempt to count or to track a number or scheduled or configured UL symbols for the UE in the first or the second bands to determine an UL duty cycle for the UE. However, RF exposure such as MPE is autonomously estimated by the UE and can also depend on other factors such as other concurrently active radio transmitters in the UE implementation, an orientation of the device, or an evaluation period over which MPE is assessed by the UE, all of which may be unknown to the gNB. Furthermore, when the UE does not transmit using high output power or hasn't reached the maximum output power according to its power class, the UE may not apply power class fallback behavior even if the maximum duty cycle is exceeded. Using existing technology, autonomy is given to the UE implementation and in consequence, the ability of the gNB to accurately estimate an available UL transmit power from the UE for a particular UL scheduling or UL transmission instance is reduced.

For example, using power class fallback or MPR based mitigation behavior according to existing technology, the UE can reduce its maximum output power to avoid exceeding an RF exposure limit such as MPE in a period of time. The UE may use power class fallback or MPR based mitigation in conjunction with a certain UL duty cycle, e.g., based on an observed or an estimated UL scheduling activity. Using existing Rel-18 NR specifications when operating in FR2, a P-MPR indication can be provided by the UE to the gNB. For example, using power headroom reporting (PHR) in a MAC CE, a UE can report its instantaneous transmit power to transmit a PUSCH. The PHR can include a power headroom value of 6 bits, a P_{CMAX,f,c} value of 6 bits, and a P-MPR value of 2 bits. The power headroom value reflects an amount of additional transmit power a UE can support when compared to the current PUSCH transmit power level. P_{CMAX,f,c} reflects the corresponding maximum power a UE could support. The P-MPR value indicates a range within which a P-MPR was autonomously applied by the UE to the current transmission. However, the PHR can only provide information reactively, e.g., after the fact. Future UE behavior, including a future adjustment of the MPR based mitigation behavior by the UE cannot be inferred by the gNB. Similar considerations apply to UE power class fallback behavior, i.e., future UE behavior with respect to the maximum output power determined by the UE for an UL transmission instance in a period may not be accurately known or predicted by the gNB.

Therefore, existing technology is insufficient to control or adjust the UE transmitter power and perform the UL transmit power control when operating in a wireless communication system.

Accordingly, embodiments of the present disclosure recognize that there is a need for separate control and/or adjustment of the UE transmitter power and UL transmit power control for bands, respectively, while ensuring compliance with applicable electromagnetic energy absorption requirements such as MPE and/or unwanted emissions or self-de-sense requirements.

Various embodiments of the present disclosure provide for separate UL duty cycle counting by UE across band X and band Y in band combination (BC). Various embodiments also provide for UL duty cycle evaluation behavior for a band or the BC based on separate UL duty cycles. For example, UL duty cycle evaluation behavior can be indicated by gNB or be provided by specifications. In one example, UL duty cycle evaluation behavior as same, or separate, or joint/common (metrics). In another example, UL duty cycle evaluation behavior/counting/metrics depending on or based on condition/restriction. Various embodiments provide for determination of UL duty cycle based on an indicated or provided adjustment or scaling value. Various embodiments provide for separate evaluation periods for band X and band Y in BC, respectively, indicated or provided. Various embodiments also provide for signaling aspects associated with the above identified embodiments. Various embodiments also provide for associated UE capability and/or UE assistance

In various embodiments, the UE is provided with information to determine first UL duty cycle corresponding to UL transmissions on a first carrier and a second UL duty cycle on a second carrier of a band, or of a band combination, or of a band combination group; based on first and second UL duty cycle the UE selects an applied power class, or determines a maximum power reduction value for an UL transmission on a carrier or in a band of the band combination or band combination group, and based on the applied PC or the MPR value, the UE determines an UL transmission power using the applied PC or the MPR value. For example, the first carrier may correspond to 6G radio access and the second carrier may correspond to one of 6G radio access or 5G/NR radio access or 4G/LTE radio access. In various embodiments, the band combination may correspond to a carrier aggregation band combination, or a dual connectivity band combination or a band combination for a UE simultaneously connected to first RAT and second RAT

In various embodiments, the UE further determines a first and a second evaluation metric based on the first and the second UL duty cycle corresponding to the first and the second carrier, respectively, to select the applied PC or to determine the MPR value and then determines UL transmit power.

In various embodiments, the UE further determines an evaluation metric based on the first and the second UL duty cycle corresponding to the first and the second carrier, respectively, wherein the evaluation metric is determined as max, or as min, or as equal weight average, or as scaled average of first and second UL duty cycle; to select the applied PC or to determine the MPR value and then determine UL transmit power.

In various embodiments, the UE is provided with information indicating to use a first and a second evaluation metric, or use one evaluation metric to select the applied PC or to determine the MPR value. In various embodiments, an UL transmission in a band is evaluated as included in a first or a second UL duty cycle when corresponding to a type of UL signal or channel and not included when not corresponding to the type; wherein a type may correspond to PUSCH, PUCCH, PRACH, or SRS. In various embodiments, an UL transmission in a carrier or in a band is evaluated as included in a first or a second UL duty cycle when exceeding a minimum UL transmission duration and not included when equal or less than the minimum transmission duration.

In certain embodiments, the UE may indicate or report to the gNB a supported UE Power Class such as defined in REF7 defining a maximum output power for any transmission bandwidth within the channel bandwidth of an NR or 6G carrier for FR1 or defining a maximum output power radiated by the UE for any transmission bandwidth within the channel bandwidth for FR2.

For example, a UE Power Class may be defined according to FR1 for FR3 operating frequencies in a range of 7-8 GHz. For example, a UE Power Class may be defined according to FR2 for FR3 operating frequencies in the range of 14-15 GHz. For example, the UE operating in FR1 or FR3 may indicate or report to the gNB a maximum output power according to power class 3 (PC3), e.g., 23 dBm, or power class 2 (PC2), e.g., 26 dBm, or power class 1.5 (PC1.5), e.g., 29 dBm. For example, PC3 may be considered a default UE Power Class for operation in FR1 or FR3.

In certain embodiments, a first or a second supported UE Power Class associated with UL transmissions corresponding to 5G/NR radio access in a first band and a second supported UE Power Class associated with UL transmissions corresponding to 6G radio access in a second band, respectively, in a band combination by the UE, can correspond to a same power class or can correspond to different power classes. For example, the UE may indicate or report to the gNB one supported UE Power Class corresponding to a band combination wherein at least one band is associated with 6G radio access. For example, the UE may indicate or report to the gNB a first and a second supported UE Power Class associated with a first and a second band, respectively, in a band combination, wherein at least one band is associated with 6G radio access.

For example, a same supported UE Power Class for a band combination with an FR1 5G/NR band and an FR3 6G band may correspond to Class 2 or PC2. For example, a first supported UE Power Class for an FR1 5G/NR band of a band combination may correspond to Class 1.5 but a second supported UE Power Class for an FR3 6G band in the band combination may correspond to Class 2. For example, a first supported UE Power Class for an FR1 5G/NR band of a band combination may correspond to Class 2 and a second (separately indicated or reported or default) supported UE Power Class for an FR3 6G band in the band combination may correspond to Class 2.

In certain embodiments, a first or a second supported UE Power Class associated with UL transmissions corresponding to 6G radio access in a first band and a second supported UE Power Class associated with UL transmissions corresponding to 6G radio access in a second band, respectively, in a band combination by the UE, can correspond to a same power class or can correspond to different power classes. For example, the UE may indicate or report to the gNB one supported UE Power Class corresponding to a band combination. For example, the UE may indicate or report to the gNB a first and a second supported UE Power Class associated with a first and a second band, respectively, in a band combination, wherein at least one band is associated with 6G radio access.

For example, a same supported UE Power Class for a band combination with an FR1 6G band and an FR3 6G band may correspond to Class 2 or PC2. For example, a first supported UE Power Class for an FR1 6G band of a band combination may correspond to Class 1.5 but a second supported UE Power Class for an FR3 6G band in the band combination may correspond to Class 2. For example, a first supported UE Power Class for an FR1 6G band of a band combination may correspond to Class 2 and a second (separately indicated or reported or default) supported UE Power Class for an FR3 6G band in the band combination may correspond to Class 2.

In one embodiment, the UE determines a first UL duty cycle associated with UL transmissions corresponding to 5G/NR radio access in an FR1 band and a second UL duty cycle associated with UL transmissions corresponding to 6G radio access in an FR3 band, respectively, for a band combination. The UE separately evaluates the number of UL transmissions or the percentage of UL transmissions occurring in a period for an UL duty cycle associated with UL transmissions corresponding to 5G/NR radio access in the FR1 band and an UL duty cycle corresponding to 6G radio access in the FR3 band, respectively, in the band combination.

In a variant, the UE determines a first UL duty cycle associated with UL transmissions corresponding to 5G/NR radio access in a first FR1 band and a second UL duty cycle associated with UL transmissions corresponding to 6G radio access in a second FR1 band, respectively, for a band combination. The UE separately evaluates the number of UL transmissions or the percentage of UL transmissions occurring in a period for an UL duty cycle associated with UL transmissions corresponding to 5G/NR radio access in the first FR1 band and an UL duty cycle corresponding to 6G radio access in the second FR1 band, respectively, in the band combination.

In a variant, the UE determines a first UL duty cycle associated with UL transmissions corresponding to 6G radio access in a first FR3 band and a second UL duty cycle associated with UL transmissions corresponding to 6G radio access in a second FR3 band, respectively, for a band combination. The UE separately evaluates the number of UL transmissions or the percentage of UL transmissions occurring in a period for an UL duty cycle associated with UL transmissions corresponding to 6G radio access in the first FR3 band and an UL duty cycle corresponding to 6G radio access in the second FR3 band, respectively, in the band combination.

In a variant, the UE determines a first UL duty cycle associated with UL transmissions corresponding to 6G radio access in a first FR2 band and a second UL duty cycle associated with UL transmissions corresponding to 6G radio access in a second FR2 band, respectively, for a band combination. The UE separately evaluates the number of UL transmissions or the percentage of UL transmissions occurring in a period for an UL duty cycle associated with UL transmissions corresponding to 6G radio access in the first FR2 band and an UL duty cycle corresponding to 6G radio access in the second FR2 band, respectively, in the band combination.

In a variant, the UE determines a first UL duty cycle associated with UL transmissions corresponding to 6G radio access in a first FR1 band and a second UL duty cycle associated with UL transmissions corresponding to 6G radio access in a second FR1 band, respectively, for a band combination. The UE separately evaluates the number of UL transmissions or the percentage of UL transmissions occurring in a period for an UL duty cycle associated with UL transmissions corresponding to 6G radio access in the first FR1 band and an UL duty cycle corresponding to 6G radio access in the second FR1 band, respectively, in the band combination.

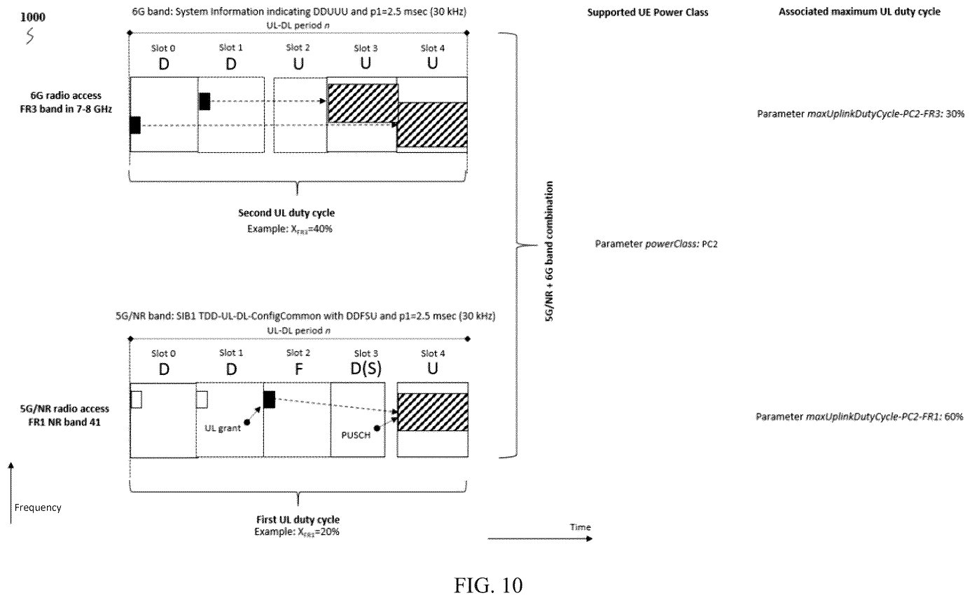

In one example and with reference to FIG. 10, the UE supports a first UL duty cycle associated with UL transmissions on a carrier in a first band corresponding to 5G/NR or 6G radio access in FR1 and a second UL duty cycle associated with UL transmissions on a carrier in a second band corresponding to 6G radio access in FR3, respectively, in a band combination. For simplicity of description and illustration purposes and without loss of generality, the example of a UE on the first carrier corresponding to 5G/NR or 6G radio access using FR1 NR band 41 and on the second carrier corresponding to 6G radio access in the FR3 7-8 GHz band is considered. The UE supporting 6G radio access indicates a supported UE Power Class, i.e., PC2, to the gNB as the power class the UE supports for UL transmissions when operating according to the band combination using a parameter powerClass comprised in UE radio access capability parameters. For example, the UE may indicate or report to the gNB a first or a second associated maximum UL duty cycle, respectively, associated with a power class for the band combination as the maximum percentage of symbols during a certain evaluation period that can be scheduled for UL transmission. For example, a maximum UL duty cycle associated with a power class may be indicated or reported by the UE to ensure compliance with applicable electromagnetic energy absorption requirements provided by regulatory bodies. For example, using a parameter maxUplinkDutyCycle-PC2-FR1, the UE may indicate a value n60, or 60%, for the first maximum UL duty cycle with respect to the FR1 carrier or band, or using a parameter maxUplinkDutyCycle-PC2-FR3, the UE may indicate a value n30, or 30%, for the second maximum UL duty cycle with respect to the FR3 carrier or band as part of the signaled UE radio access capability parameters.

A number of UL transmissions in the FR1 carrier or band or in the FR3 carrier or band of the band combination over a period of time may be scheduled or configured for the UE by the gNB wherein some UL transmissions can be scheduled or configured in the FR1 carrier or band and some UL transmissions can be scheduled or configured in the FR3 carrier or band.

When transmitting an UL signal or channel in the FR1 carrier or band of the band combination, the UE counts the UL transmission with respect to the first UL duty cycle associated with UL transmissions corresponding to 5G/NR or 6G radio access but does not count the UL transmission with respect to the second UL duty cycle associated with UL transmissions corresponding to 6G radio access in the FR3 carrier or band. For example, the first UL percentage of UL symbols transmitted in the FR1 carrier or band may be determined by the UE with reference to a certain evaluation period. When transmitting an UL signal or channel in the FR3 carrier or band of the band combination, the UE counts the UL transmission with respect to the second UL duty cycle associated with UL transmissions corresponding to 6G radio access but does not count the UL transmission with respect to the first UL duty cycle associated with UL transmissions corresponding to 5G/NR or 6G radio access in the FR1 carrier or band. For example, the second UL percentage of UL symbols transmitted in the FR3 carrier or band may be determined by the UE with reference to a certain evaluation period. For example, the UE may determine a value for the first UL duty cycle in the FR1 carrier or band such as X_{FR1}=20% in a certain evaluation period and a value for the second UL duty cycle such as X_{FR3}=40% in a certain evaluation period.

FIG. 10 illustrates an example timeline 1000 of a separate UL duty cycle evaluation in a first and a second band of a band combination for a wireless communication system according to embodiments of the present disclosure; The timeline 1000 of FIG. 10 can be utilized or followed by any of the UEs 111-111 of FIG. 1, such as the UE 111 of FIG. 3, and any of the BSs 101-103 of FIG. 1, such as BS 102 of FIG. 2. The timeline 1000 is for illustration only and other embodiments can be used without departing from the scope of the present disclosure.

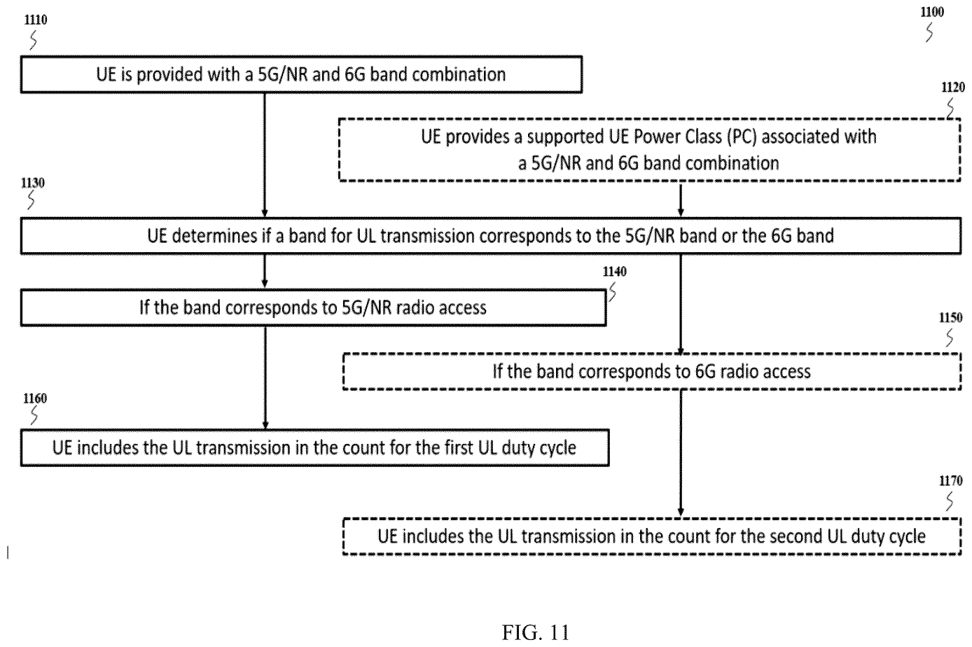

FIG. 11 illustrates an example flowchart for a process 1100 of a separate UL duty cycle evaluation in a first and a second band of a band combination for a wireless communication system according to embodiments of the present disclosure. The method 1100 of FIG. 11 can be performed by any of the UEs 111-111 of FIG. 1, such as the UE 111 of FIG. 3, and a corresponding method can be performed by any of the BSs 101-103 of FIG. 1, such as BS 102 of FIG. 2. The method 1100 is for illustration only and other embodiments can be used without departing from the scope of the present disclosure.

The process 1100 begins with the UE being provided with a 5G/NR and 6G band combination (1110). The UE provides a supported UE PC associated with a 5G/NR and 6G band combination (1120). The UE determines if a band for UL transmission corresponds to the 5G/NR band or the 6G band (1130) If the band corresponds to 5G/NR radio access (1140), the UE includes the UL transmission in the count for the first UL duty cycle (1160). If the band corresponds the 6G radio access (1150), the UE includes the UL transmission in the count for the second UL duty cycle (1170).

Based on the first or the second UL duty cycle associated with UL transmissions on the carrier in the first band, e.g., FR1 NR band 41, corresponding to 5G/NR or 6G radio access and on the carrier in the second band corresponding to 6G radio access in FR3, e.g., FR3 band 7-8 GHz, respectively, the UE may further determine a UE Power Class according to which a UE maximum output power may be applied, or the UE may further determine a maximum power reduction value corresponding to a later UL transmission power for an UL transmission in a band of the band combination as further elaborated by the embodiments.

For example, the UE can select a UE Power Class based on a first supported UE Power Class associated with UL transmissions corresponding to 5G/NR or 6G radio access in the first band in FR1 based on the first UL duty cycle and a second supported UE Power Class associated with UL transmissions corresponding to 6G radio access in the second band in FR3 based on the second UL duty cycle, respectively, in the band combination, to further determine a maximum output power and/or apply the corresponding transmitter power requirements according to the selected UE Power Class.

For example, the UE can select a UE Power Class based on the supported UE Power Class associated with UL transmissions in the band combination corresponding to 5G/NR or 6G radio access in the first band in FR1 and corresponding to 6G radio access in the second band in FR3, respectively, based on the first or the second UL duty cycle to further determine a maximum output power and/or apply the corresponding transmitter power requirements according to the selected UE Power Class.

For example, the UE can determine a first maximum power reduction value for an UL transmission corresponding to 5G/NR or 6G radio access in the first band in FR2 and a maximum second power reduction value for an UL transmission corresponding to 6G radio access in the second band in FR3, respectively, in the band combination, to further determine an UL transmission power and/or apply the corresponding transmitter power requirements.

In one embodiment, the UE determines a UE Power Class according to which a UE maximum output power may be applied, or the UE determines a maximum power reduction value corresponding to an UL transmission power for an UL transmission in a band of the band combination based on a first UL duty cycle or a second UL duty cycle, respectively, wherein the first or the second UL duty cycle may correspond to UL transmissions in an FR1, or an FR2, or an FR3 band of a band combination.

For example, and with reference to FIG. 10, the UE may select a UE Power Class to determine a UE maximum output power associated with UL transmissions corresponding to 5G/NR or 6G radio access in the FR1 carrier or band and with UL transmissions corresponding to 6G radio access in the FR3 carrier or band, respectively, in the band combination based on a separate UL duty cycle evaluation behavior. For example, the UE may compare a value determined for the first UL duty cycle in the FR1 carrier or band, e.g., X_{FR1}=20%, in a certain evaluation period to a first threshold value, e.g., X_{FR1, TH}=60%. For example, the UE may compare a value determined for the second UL duty cycle, e.g., X_{FR3}=40%, in a certain evaluation period to a second threshold value, e.g., X_{FR3, TH}=30%. The first and the second threshold values may be a same value or correspond to different values. For example, when the supported UE Power Class of the band combination enables the higher maximum output power than that of the default power class, the UE may select a configured transmitted power according to the default power class when the value of an UL duty cycle is higher than a threshold value, and the UE may select a configured transmitted power according to the supported power class when the value of an UL duty cycle is smaller than and/or equal to a threshold value. In the example, for the values X_{FR1}=20%, X_{FR1, TH}=60%, X_{FR3}=40% and X_{FR3, TH}=30%, the UE may then select the supported (higher) PC2 to determine the maximum output power for a later UL transmission in the FR1 carrier or band and select the default PC3 to determine the maximum output power in the FR3 carrier or band, respectively, of the band combination and/or apply the corresponding transmitter power requirements.

For example, when a UE supports a different power class, i.e., PC2, from the default UE power class for the FR3 band and the supported power class enables the higher maximum output power than that of the default power class for the FR3 band in the band combination, if the field of UE capability maxUplinkDutyCycle-PC2-FR3 is absent and the percentage of UL symbols transmitted in a certain evaluation period on the carrier in the FR3 band is larger than X_{FR3, TH}, or if the field of UE capability maxUplinkDutyCycle-PC2-FR3 is not absent and the percentage of UL symbols transmitted in a certain evaluation period on the carrier in the FR3 band is larger than maxUplinkDutyCycle-PC2-FR3, the UE then applies all requirements for the default power class to the supported power class, e.g., PC3, and sets the configured transmitted power accordingly; else the UE applies all requirements for the supported power class; and sets the configured transmitted power.

Similar considerations can be applied with respect to determination or selection of a maximum power reduction value for an UL transmission in an FR1, or FR2, or FR3 band using 5G/NR or 6G radio access and for an UL transmission in an FR1, or FR2 or FR3 band, respectively. For example, a maximum power reduction value may correspond to a P-MPR value. For example, for the set of example values X_{FR3}=40%, X_{FR3, TH}=30%, X_{FR2}=20%, and X_{FR2, TH}=60% in a first band corresponding to 6G radio access in FR3 band 14-15 GHz and a second band corresponding to 5G/NR or 6G radio access in FR2-1 in the band combination, the UE might then determine a first P-MPR value such as P-MPR_{FR3}=−6 dB with respect to an UL transmission on the carrier in the FR3 band and a second P-MPR value such as P-MPR_{FR2}=0 dB with respect to an UL transmission on the carrier in the FR2-1 band, respectively, when determining a configured transmitted output power.

For example, and with reference to FIG. 10, based on the first or the second UL duty cycle associated with UL transmissions on the carrier in the first band, e.g., FR1 NR band 41, corresponding to 5G/NR or 6G radio access and on the carrier in the second band corresponding to 6G radio access in FR3, e.g., FR3 band 7-8 GHz, respectively, in a band combination, the UE may further apply an UL duty cycle evaluation behavior. For example, the UL duty cycle evaluation behavior may correspond to a same, or a separate or a joint/common type of UL duty cycle evaluation behavior. Based on the UL duty cycle evaluation behavior, the UE may further determine a UE Power Class according to which a UE maximum output power may be applied, or the UE may further determine a maximum power reduction value corresponding to a later UL transmission power of an UL transmission in a band of the band combination as further described by the embodiments.

The UE may determine an UL duty cycle associated with UL transmissions in a first carrier or band or a second carrier or band, respectively, in the band combination, based on a condition or restriction, as further described by the embodiments. For example, the UE may assume a reference set of symbols/slots on a carrier in a band of a band combination. For example, the UE may be provided with information by the gNB for a reference set of symbols/slots on a carrier to evaluate or to determine an UL duty cycle associated with UL transmissions in the carrier. For example, the UE may be provided with information to include or not to include a type of UL signal or channel in a number of UL transmissions in a period in a carrier, or in a band, or in a band combination to determine an UL duty cycle as further described by the embodiments.

The UE may determine an UL duty cycle associated with UL transmissions in a first carrier or band and a second carrier or band, respectively, in the band combination, based on an adjustment factor, as further described by the embodiments. For example, the adjustment factor with respect to an UL duty cycle may correspond to a scaling, a weighting, a counting increase or reduction, or a use of a maximum or a minimum, or a threshold value with respect to a first and/or a second UL duty cycle or a number or a type of UL transmissions in a carrier in a band. For example, the UE may determine a value for a second UL duty cycle associated with UL transmissions in a second carrier or band in a band combination using a value for a first UL duty cycle associated with UL transmissions in a first carrier or band in the band combination and using an adjustment factor as further described by the embodiments. For example, the adjustment factor with respect to the first UL duty cycle may correspond to a scaling value X_{SCALE} such as X_{SCALE}=0.5; wherein the UE may determine a value for the second UL duty cycle in the second band based on a number of equivalent or assumed or scaled UL transmissions according to a value for the first UL duty cycle in the first band. For example, the UE may determine an equivalent or an assumed or scaled value for the UL duty cycle in the 6G FR3 band as X_{FR3}=X_{SCALE}*X_{FR1}=20% for X_{FR1}=40% and X_{SCALE}=0.5.

For example, a value for a supported maximum UL duty cycle associated with a UE Power Class for a carrier or a band may correspond to a default UL duty cycle, e.g., 50%. The absence of a field or value indicative of a supported maximum UL duty cycle other than the default UL duty cycle in the corresponding UE radio access capability parameters may imply that the UE supports the default UL duty cycle associated with the UE Power Class for UL transmissions in the FR3 6G carrier or band. Alternatively, a supported maximum UL duty cycle associated with a UE Power Class may be separately indicated or reported by the UE to the gNB as a value or a setting in the UE radio access capability parameters. For example, a value for a default UL duty cycle associated with a UE power Class may be same or correspond to a different value when corresponding to FR1 6G/NR radio access or to FR3 6G radio access, respectively. For example, a value for a default UL duty cycle for an FR1 PC2 may correspond to a percentage X_{FR1, DEFAULT}=50% but a separate default UL duty cycle for an FR3 PC2 may correspond to X_{FR3, DEFAULT}=40%. For example, a value of a default UL duty cycle associated with a UE Power Class for an FR3 band or for an FR3 band in a band combination may be indicated or tabulated or provided by system operating specifications. Furthermore, a value for a default UL duty cycle associated with a UE Power Class in an FR3 band may be further associated with a condition or a restriction.

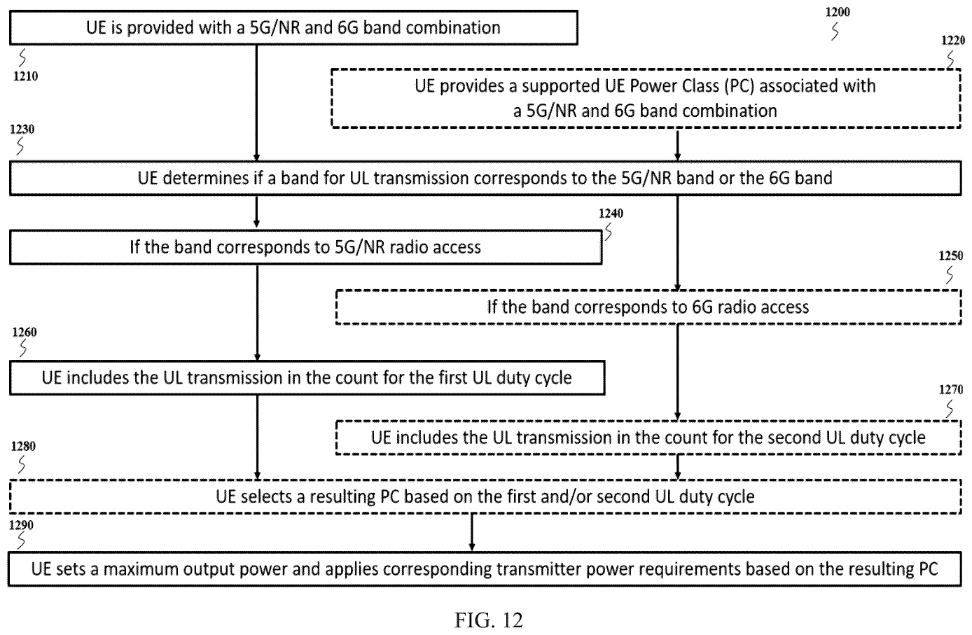

FIG. 12 illustrates an example flowchart for a process 1200 of a separate UL duty cycle evaluation in a first and a second band of a band combination to determine an UL maximum output power for a wireless communication system according to embodiments of the present disclosure. The method 1200 of FIG. 12 can be performed by any of the UEs 111-112 of FIG. 1, such as the UE 112 of FIG. 3, and a corresponding method can be performed by any of the BSs 101-103 of FIG. 1, such as BS 102 of FIG. 2. The method 1200 is for illustration only and other embodiments can be used without departing from the scope of the present disclosure.

The process 1200 begins with the UE being provided with a 5G/NR and 6G band combination (1210). The UE provides a supported UE PC associated with a 5G/NR and 6G band combination (1220). The UE determines if a band for UL transmission corresponds to the 5G/NR band or the 6G band (1230). If the band corresponds to 5G/NR radio access (1240), the UE includes the UL transmission in the count for the first UL duty cycle (1260). If the band corresponds to 6G radio access (1250), the UE includes the UL transmission in the count for the second UL duty cycle (1270). The UE selects a resulting PC based on the first and/or second UL duty cycle (1280). The UE sets a maximum output power and applies corresponding transmitter power requirements based on the resulting PC (1290).

Similar considerations based on the examples can be extended to other cases such as other UE Power Classes, e.g., PC1.5 or PC1, or to other cases such as when the UE operates according to a band combination across FR1, FR2, or FR3, or according to a band combination within a same frequency range such as within FR1, or within FR2, or within FR3, or to other cases such as when UL transmission in a carrier or in a band are based on 6G radio access or 4G/LTE radio access instead of 5G/NR radio access.

A motivation is that support for separate UL duty cycle evaluation by a UE for an FR1 band using 5G/NR or 6G radio access and an FR3 band using 6G radio access in a band combination by a UE can enable separate control and adjustment of the UE maximum output power, for example based on an associated power class fallback behavior when a maximum or a default UL duty cycle value is exceeded during UL transmission in the 5G/NR or 6G band and in the 6G band of the band combination, respectively. This can benefit the achievable UL coverage or UL data rate for a UE supporting 6G radio access.

For example, when UL transmissions for the UE are preferably scheduled or configured by the gNB in the FR3 6G band 7-8 GHz where less interference may be incurred due to a reduced loading or where lower target receive power settings may be employed than in the FR1 5G/NR or 6G band, it may be preferable to not reduce the UE maximum output power in the FR3 6G band and rather apply a power class fallback according to a maximum or default UL duty cycle, if needed, to the FR1 5G/NR or 6G band first. This is because for some FR3 mMIMO antenna configurations, more SINR per slot/symbol may be collected by the gNB than in the FR1 band. If the UE reduces a maximum output power based on PC fallback mitigation procedures, for example to comply with electromagnetic energy absorption requirements, the maximum output power in the FR3 6G 7-8 GHz band should preferably be reduced last. An UL coverage or an UL throughput for the UE can then be improved in the 6G band. Existing technology would reduce the UE maximum output power in both bands of the band combination according to the same UE power class fallback behavior which is undesirable.

In another example, it may be more advantageous to use the supported UE maximum output power for UL transmissions from the UE on the carrier in the FR1 5G/NR or 6G band such as when PUSCH repetition in an FR1 5G/NR or 6G FDD lower band is configured for a UE at cell edge or in low SINR operating conditions. When a UE maximum output power is reduced by the UE according to a power class fallback procedure according to a maximum or default UL duty cycle for the FR1-FR3 band combination, for example to comply with electromagnetic energy absorption requirements, it may be preferable to maintain the supported UE maximum output power for the FR1 5G/NR or 6G lower band providing coverage, and separately adjust or reduce a UE maximum output power for the FR3 6G higher band used as capacity booster where the use of a lower than supported UE power class may result in reduced impact, for example when the cells for FR1 and FR3 are not co-located and the UE is closer to the gNB using FR3 providing data capacity and is further away from the gNB using FR1 providing coverage. Using existing technology for UEs based on dual connectivity operation, for example the gNB may reduce UL scheduling activity on the FR3 6G band in the band combination for the UE, to reduce a contribution to the UL duty cycle from the FR3 6G band, but the UE autonomous behavior in existing technology with respect to the maximum output power determined by the UE according to the UL duty cycle for an UL transmission instance in a period may not be accurately known or predicted by the gNB for periods of several seconds or more. UE power class fallback according to a same UL duty cycle based on existing technology can then result in radio link interruption due to lower than required UL transmission power in the 5G/NR or 6G band which is undesirable. For UEs supporting 6G radio access, such scheduling coordination between the lower band 5G/NR or 6G radio access network function and the higher band 6G radio access network function to reduce an UL duty cycle in the FR3 6G band by the radio access network may not be possible, even in CA operation where the schedulers can be independent among cells and may not be able to communicate without delays. An UL coverage and link robustness for the UE supporting 6G radio access can then be improved.

In one embodiment, based on a first or a second UL duty cycle associated with UL transmissions on a carrier in a first band corresponding to 5G/NR or 6G radio access and on a carrier in a second band corresponding to 6G radio access, respectively, in a band combination, the UE selects and/or applies an UL duty cycle evaluation behavior wherein the UL duty cycle evaluation behavior may correspond to a same, or a separate, or a joint/common type of UL duty cycle evaluation behavior. Based on the selected UL duty cycle evaluation behavior, the UE may further determine a UE Power Class according to which a UE maximum output power may be applied, or the UE may further determine a maximum power reduction value corresponding to a later UL transmission power of an UL transmission in a band of the band combination.

For example, an UL duty cycle evaluation behavior corresponding to the first or the second UL duty cycle may be provided or indicated to the UE by the gNB based on one of or a combination of DCI-based signaling, L1 control signaling, RRC signaling, or MAC CE signaling, or NAS based signaling. For example, an UL duty cycle evaluation behavior corresponding to the first or the second UL duty cycle may be provided by system operating specifications. For example, an UL duty cycle evaluation behavior corresponding to the first or the second UL duty cycle may be selected by the UE according to a condition.

In one embodiment the UE is indicated by the gNB with an UL duty cycle evaluation behavior to apply for a first or a second band, respectively, in a band combination wherein the UL duty cycle evaluation behavior may correspond to a same, or a separate, or a joint/common type of UL duty cycle evaluation behavior. Based on the indication from the gNB, the UE determines the UL duty cycle evaluation behavior for a later UL transmission for the first band or the second band, respectively, in the band combination.

A motivation for a provided UL duty cycle evaluation behavior, or UL duty cycle evaluation mode, is that separate control and adjustment of the UE maximum output power with respect to UL transmission in the first 5G/NR or 6G band and the second 6G band of the band combination can be selected by the network according to the needs of the deployment. For example, a same UL duty cycle behavior or counting by the UE supporting 6G radio access may be preferred when 5G/NR or 6G radio access on a first carrier and 6G radio access on a second carrier operate in close bands and a same UL RF front-end may be used, e.g., within FR1, or when operating according to carrier aggregation. For example, a separate UL duty cycle behavior or counting by the UE supporting 6G radio access may be preferred when 5G/NR or 6G radio access on the first carrier and 6G radio access on the second carrier operate in wider separated bands where separate UL RF front-ends may be used, e.g., across FR1 and FR3, or where gNB scheduling with respect to an MCG and SCG may operates without exchange of real-time scheduling decisions. For example, a joint or common UL duty cycle behavior or counting by the UE supporting 6G radio access may be preferred when gNB scheduling with respect to 5G/NR or 6G radio access on the first carrier and 6G radio access on the second carrier may operate without exchange of real-time scheduling decisions, an UL duty cycle with respect to MCG scheduling may be estimated by a gNB, and a potential impact on a total UE maximum output power from separate SCG scheduling may be bounded or estimated by the MCG scheduling based on an assumed or scaled UL duty cycle with respect to the SCG scheduling.

When one supported UE Power Class is provided by the UE for the band combination, or when the first and the second supported UE Power Class in the band combination provided by the UE are same, a same UL duty cycle behavior may be applied by the UE to further determine a maximum output power and/or apply the corresponding transmitter power requirements according to the selected UE Power Class based on the supported UE Power Class associated with UL transmissions corresponding to 5G/NR or 6G radio access on the first carrier or 6G radio access on the second carrier to set an UL transmitter power.

In one example for a same UL duty cycle evaluation behavior, when transmitting an UL signal or channel in the FR1 carrier or band or in the FR3 carrier or band of the band combination, the UE may count the UL transmission with respect to an UL duty cycle associated with UL transmissions. For example, when transmitting an UL signal or channel in the FR1 or the FR3 carrier or band of the band combination, the UE may count the UL transmissions with respect to an UL duty cycle associated with UL transmissions corresponding to 5G/NR or 6G radio access on the first carrier or 6G radio access on the second carrier in the FR3 carrier or band. For example, the UE may determine an UL percentage of UL symbols transmitted in the FR1 carrier or band or in the FR3 carrier or band in a period of time with reference to a certain evaluation period.

When the first and the second supported UE Power Class in the band combination are same or different, a separate UL duty cycle behavior can be applied by the UE. A first selected or applied UE Power Class is determined by the UE based on the first supported UE Power Class for the first band in the band combination and based on the first UL duty cycle. A second selected or applied UE Power Class is determined by the UE based on the second supported UE Power Class for the second band in the band combination and based on the second UL duty cycle. The UE then may further determine a maximum output power and/or apply the corresponding transmitter power requirements according to a selected or applied UE Power Class to set an UL transmitter power for UL transmissions in the first band and in the second band, respectively.

In one example for a separate UL duty cycle evaluation behavior and with reference to FIG. 10, when transmitting an UL signal or channel in the FR1 carrier or band of the band combination, the UE counts the UL transmission with respect to the first UL duty cycle associated with UL transmissions corresponding to 5G/NR or 6G radio access but does not count the UL transmission with respect to the second UL duty cycle associated with UL transmissions corresponding to 6G radio access in the FR3 carrier or band. For example, the first UL percentage of UL symbols transmitted in the FR1 carrier or band may be determined by the UE with reference to a certain evaluation period. When transmitting an UL signal or channel in the FR3 carrier or band of the band combination, the UE counts the UL transmission with respect to the second UL duty cycle associated with UL transmissions corresponding to 6G radio access but does not count the UL transmission with respect to the first UL duty cycle associated with UL transmissions corresponding to 5G/NR or 6G radio access in the FR1 carrier or band. For example, the second UL percentage of UL symbols transmitted in the FR3 carrier or band may be determined by the UE with reference to a certain evaluation period.

When the first and the second supported UE Power Class in the band combination are same or different, a joint or common UL duty cycle evaluation behavior can be applied by the UE. For example, UE may determine an effective UL duty cycle based on the first and the second UL duty cycle based on an adjustment factor. For example, the UE may determine a second, i.e., assumed or equivalent, UL duty cycle based on a first UL duty cycle and an adjustment factor. The UE then further determines a maximum output power and/or applies the corresponding transmitter power requirements according to a selected UE Power Class corresponding to 5G/NR radio access or 6G radio access in a band of the band combination, or corresponding to 6G radio access on a first carrier or 6G radio access on a second carrier in a band or in a band combination to set an UL transmitter power using the evaluation metric or the assumed or equivalent UL duty cycle. For example, an adjustment factor may correspond to a scaling factor, or a weighting factor, or a counting increase or reduction, or an averaging, or a determination of a maximum or a minimum value, or an application of a threshold value with respect to a first or a second UL duty cycle or with respect to a number of symbols or a type of UL transmissions in a carrier in a band.

In one example for a joint or common UL duty cycle evaluation behavior based on an adjustment factor, the UE determines a first and a second UL duty cycle corresponding to UL transmissions in the first 5G/NR or 6G carrier or band and in the second 6G carrier or band of the band combination, respectively. For example, when transmitting an UL signal or channel in the FR1 carrier or band of the band combination, the UE counts the UL transmission with respect to the first UL duty cycle associated with UL transmissions corresponding to 5G/NR or 6G radio access but does not count the UL transmission with respect to the second UL duty cycle associated with UL transmissions corresponding to 6G radio access in the FR3 carrier or band. When transmitting an UL signal or channel in the FR3 carrier or band of the band combination, the UE counts the UL transmission with respect to the second UL duty cycle associated with UL transmissions corresponding to 6G radio access but does not count the UL transmission with respect to the first UL duty cycle associated with UL transmissions corresponding to 5G/NR or 6G radio access in the FR1 carrier or band. For example, the UE may determine the effective UL duty cycle as the larger value, i.e., a maximum value, of the first or the second UL duty cycle in a certain evaluation period. For example, when the UE determines a value for the first UL duty cycle as X_{FR1}=60% corresponding to 5G/NR or 6G radio access in an evaluation period and a value for the second UL duty cycle as X_{FR3}=30% corresponding to 6G radio access in an evaluation period, the UE determines the effective UL duty cycle for the band combination as X_{eff}=max(X_{FR1}, X_{FR3}) or 60%. Based on the effective UL duty cycle, the UE may further determine or select a resulting UE Power Class, and determine a maximum output power and/or apply the corresponding transmitter power requirements according to the resulting UE Power Class to set an UL transmitter power for UL transmissions in the first band corresponding to 5G/NR or 6G radio access and the second band corresponding to 6G radio access, respectively.

In another example for a joint or common UL duty cycle evaluation behavior based on an adjustment factor, the UE determines a first and a second UL duty cycle corresponding to UL transmissions in the first 5G/NR or 6G carrier or band and in the second 6G carrier or band of the band combination, respectively. For example, the UE may determine the effective UL duty cycle as a scaled value with respect to the first or the second UL duty cycle in a certain evaluation period. For example, when the UE determines a value for the first UL duty cycle as X_{FR1}=40% corresponding to 5G/NR or 6G radio access in an evaluation period and a value for the second UL duty cycle as X_{FR3}=50% corresponding to 6G radio access in an evaluation period, and using a scaling factor X_{SCALE}=0.5, the UE determines the effective UL duty cycle for the band combination as X_{eff}=max(X_{FR1}, X_{SCALE}*X_{FR3}) or 40%. Based on the effective UL duty cycle, the UE may further determine or select a resulting UE Power Class, and determine a maximum output power and/or apply the corresponding transmitter power requirements according to the resulting UE Power Class to set an UL transmitter power for UL transmissions in the first band corresponding to 5G/NR or 6G radio access and the second band corresponding to 6G radio access, respectively.

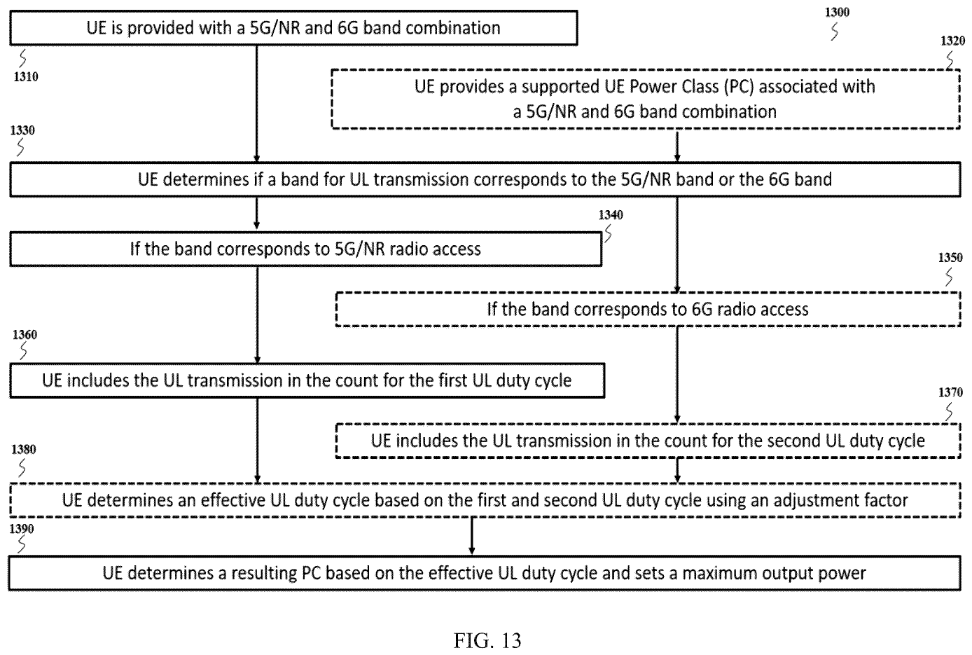

FIG. 13 illustrates an example flowchart for a process 1300 of an effective UL duty cycle evaluation based on an adjustment factor in a band combination for a wireless communication system according to embodiments of the present disclosure. The method 1300 of FIG. 13 can be performed by any of the UEs 111-113 of FIG. 1, such as the UE 113 of FIG. 3, and a corresponding method can be performed by any of the BSs 101-103 of FIG. 1, such as BS 102 of FIG. 2. The method 1300 is for illustration only and other embodiments can be used without departing from the scope of the present disclosure.

The process 1300 begins with the UE being provided with a 5G/NR and 6G band combination (1310). The UE provides a supported UE PC associated with a 5G/NR and 6G band combination (1320). The UE determines if a band for UL transmission corresponds to the 5G/NR band or the 6G band (1330). If the band corresponds to 5G/NR radio access (1340), the UE includes the UL transmission in the count for the first UL duty cycle (1360). If the band corresponds to 6G radio access (1350), the UE includes the UL transmission in the count for the second UL duty cycle (1370). The UE determines an effective UL duty cycle based on the first and second UL duty cycle using an adjustment factor (1380). The UE determines a resulting PC based on the effective UL duty cycle and sets a maximum output power (1390).

In one example for a joint or common UL duty cycle evaluation behavior based on an adjustment factor, a first UL duty cycle is determined by the UE for the first band in the band combination. The UE determines a value for an assumed or an equivalent second UL duty cycle based on the first UL duty cycle and the adjustment factor. For example, the UE may determine a first value corresponding to a first UL duty cycle associated with UL transmissions in a first carrier or band corresponding to 5G/NR or 6G radio access, e.g., the UE may count the UL transmissions in a period on the first carrier or band. The UE determines a second value for an assumed or an equivalent UL duty cycle with respect to a second carrier or band corresponding to 6G radio access using the first value and an adjustment factor. For example, the adjustment factor may correspond to a scaling value X_{SCALE} such as X_{SCALE}=0.5. For example, when the UE determines a value for the first UL duty cycle as X_{FR1}=40% corresponding to 5G/NR or 6G radio access in the first carrier or band of the band combination in an evaluation period; using a scaling factor X_{SCALE}=0.5, the UE determines an effective, i.e., assumed or equivalent, UL duty cycle corresponding to 6G radio access in the second carrier or band for the band combination as X_{FR3,eff}=X_{SCALE}*X_{FR1} or 20%. Based on the effective UL duty cycle, the UE may further determine or select a resulting UE Power Class, and determine a maximum output power and/or apply the corresponding transmitter power requirements according to the resulting UE Power Class to set an UL transmitter power for UL transmissions in the first and/or the second band of the band combination.

In another example for a joint or common UL duty cycle evaluation behavior based on an adjustment factor, the UE determines a first UL duty cycle corresponding to UL transmissions in the first 5G/NR or 6G carrier or band. For example, the UE counts the UL transmission with respect to the first UL duty cycle associated with UL transmissions corresponding to 5G/NR or 6G radio access but does not count the UL transmission with respect to the second UL duty cycle associated with UL transmissions corresponding to 6G radio access in the FR3 carrier or band. For example, the UE may determine the effective UL duty cycle with respect to the second UL duty cycle in a certain evaluation period based on a threshold value. When transmitting an UL signal or channel in the FR3 carrier or band of the band combination, the UE counts the UL transmission with respect to the second UL duty cycle associated with UL transmissions corresponding to 6G radio access when an UL transmission corresponds to more than a value TH of time-domain symbols, and does not count the UL transmission with respect to the second UL duty cycle when equal or less than TH symbols, and does not count the UL transmission with respect to the first UL duty cycle associated with UL transmissions corresponding to 5G/NR or 6G radio access in the FR1 carrier or band. For example, the UE may determine the effective UL duty cycle as the resulting value for the second UL duty cycle when only including UL transmissions resulting in more than TH symbols in a certain evaluation period. For example, when the UE determines a value for the first UL duty cycle as X_{FR1}=60% corresponding to 5G/NR radio access in an evaluation period and a value for the second UL duty cycle including any UL transmission as X_{FR3}=10% corresponding to 6G radio access in an evaluation period with respect to UL transmissions in the FR3 carrier or band of 1-symbol SRS transmissions occurring in non-consecutive symbols, the UE determines the effective UL duty cycle for FR3 6G carrier or band as X_{FR3,eff}=0%. Based on the effective UL duty cycle, the UE may further determine or select a resulting UE Power Class, and determine a maximum output power and/or apply the corresponding transmitter power requirements according to the resulting UE Power Class to set an UL transmitter power for UL transmissions in the first band corresponding to 5G/NR or 6G radio access and/or the second band corresponding to 6G radio access, respectively.

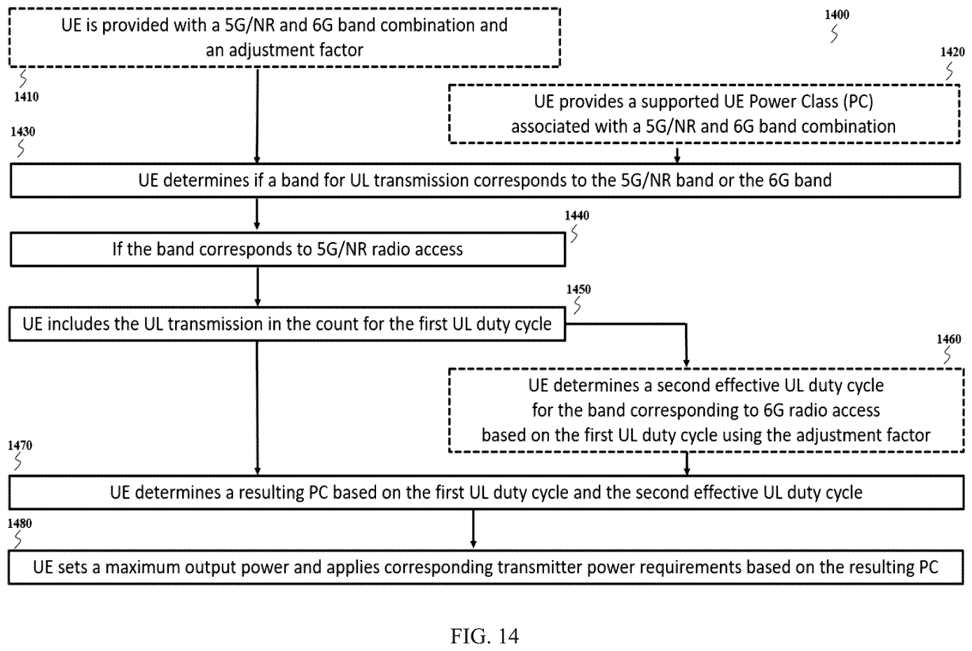

FIG. 14 illustrates an example flowchart for a process 1400 of a second effective UL duty cycle evaluation based a first UL duty cycle evaluation and an adjustment factor in a band combination for a wireless communication system according to embodiments of the present disclosure. The method 1400 of FIG. 14 can be performed by any of the UEs 111-114 of FIG. 1, such as the UE 114 of FIG. 3, and a corresponding method can be performed by any of the BSs 101-103 of FIG. 1, such as BS 102 of FIG. 2. The method 1400 is for illustration only and other embodiments can be used without departing from the scope of the present disclosure.

The process 1400 begins with the UE being provided with a 5G/NR and 6G band combination and an adjustment factor (1410). The UE provides a supported UE PC associated with a 5G/NR and 6G band combination (1420). The UE determines if a band for UL transmission corresponds to the 5G/NR band or the 6G band (1430). If the band corresponds to 5G/NR radio access (1440), the UE includes the UL transmission in the count for the first UL duty cycle (1450). The UE determines a second effective UL duty cycle for the band corresponding to 6G radio access based on the first UL duty cycle using the adjustment factor (1460). The UE determines a resulting PC based on the first UL duty cycle and the second effective UL duty cycle (1470). The UE sets a maximum output power and applies corresponding transmitter power requirements based on the resulting PC (1480).

Similar considerations based on the examples can be extended to other cases such as other UE Power Classes, e.g., PC1.5 or PC1, or to other cases such as when the UE operates according to a band combination across FR1, FR2, or FR3, or according to a band combination within a same frequency range such as within FR1, or within FR2, or within FR3, or to other cases such as when UL transmission in a carrier or in a band are based on 6G radio access or 4G/LTE radio access instead of 5G/NR radio access.

In one embodiment the UE is provided with information for an UL duty cycle evaluation behavior to apply for a first or a second carrier or band, respectively, in a band combination wherein the UL duty cycle evaluation behavior corresponds to a desired, or a preferred, or an allowed, or an enabled, or a requested, or a prioritized carrier or band on which to apply an UL duty cycle evaluation. Based on the provided information, the UE determines the UL duty cycle evaluation behavior for a later UL transmission for the first band or the second band, respectively, in the band combination.

For example, an UL duty cycle evaluation behavior corresponding to a desired, or a preferred, or an allowed, or an enabled, or a requested, or a prioritized carrier or band may be provided or indicated to the UE by the gNB based on one of or a combination of DCI-based signaling, L1 control signaling, RRC signaling, MAC CE signaling, or NAS based signaling. For example, an UL duty cycle evaluation behavior corresponding to the first or the second UL duty cycle may be provided by system operating specifications. For example, an UL duty cycle evaluation behavior corresponding to the first or the second UL duty cycle may be selected by the UE according to a condition.

In a variant, the UL duty cycle evaluation behavior to apply for a first or a second carrier or band, respectively, in a band combination, may correspond to a sequence or a list providing a preference or order of carriers or bands according to which an UL duty cycle evaluation may be applied first or last in the band combination.

For example, the UL duty cycle evaluation behavior may correspond to an indication received by the UE from the gNB for a desired, or a preferred, or an allowed, or an enabled, or a requested, or a prioritized carrier or band in a band combination on which the UL duty cycle evaluation should be applied. For example, a UL duty cycle evaluation behavior may correspond to an indication received by the UE from the gNB for a not desired, or a not preferred, or a disallowed, or a disabled carrier or band on which the UL duty cycle evaluation should not be applied. More than one desired, or preferred, or allowed, or enabled, or requested, or prioritized or more than one not desired, or not preferred, or disallowed, or disabled carrier or band with respect to UL duty cycle evaluation or counting may be indicated to the UE, i.e., indicated as a set. When a set is indicated, and more than one carrier or band can be selected by the UE with respect to an UL duty cycle evaluation, a suitable rule can be defined to determine a carrier or band from the set. For example, the UE may select the first carrier or band in a list or in a set for UL duty cycle evaluation, etc.

In one example, when the UE receives an UL duty cycle evaluation indication from the gNB wherein the UL duty cycle evaluation behavior corresponds to a requested carrier or band, the UE counts an UL transmission in the corresponding carrier or band to determine an UL duty cycle. For example, when the UE receives an UL duty cycle evaluation indication corresponding to a requested FR1 5G/NR or 6G band, the UE then counts the UL transmissions in the FR1 5G/NR or 6G band to determine an UL duty cycle but does not count UL transmission in the FR3 6G band.

For example, the UE may be indicated by the gNB with a UL duty cycle evaluation behavior to apply on a carrier in a band of the band combination wherein the UL duty cycle evaluation behavior corresponds to a provided set of time-domain resources, i.e., a set of slots/symbols on the carrier or in the band. Based on the indication from the gNB, the UE determines the UL duty cycle evaluation behavior for a later UL transmission in the set of slots/symbols, respectively, on the carrier or in the band.

For example, a set of slots/symbols associated with a UL duty cycle evaluation behavior or with UL duty cycle counting may be provided to the UE by higher layers. For example, a DCI-based indication may be used to provide the UE with information for the set of slots/symbols associated with a UL duty cycle evaluation behavior or with UL duty cycle counting. For example, the set of slots/symbols associated with a UL duty cycle evaluation behavior, or a UL duty cycle counting may be tabulated and/or listed by system operating specifications. One or a combination of these methods may be used. For example, a UL duty cycle evaluation behavior or an UL duty cycle counting may be associated with an UL signal or channel type such as corresponding to UL transmissions of a PUCCH, PUSCH, SRS or PRACH by the UE. For example, a first and a second set of slots/symbols on a serving cell associated with a UL duty cycle evaluation indication may be configured or indicated to the UE, respectively. For example, a set of symbols/slots or a set of symbol/slot identifiers associated with a set of slots/symbols may correspond to a bitmap or a list of slots/symbols or a SLIV value with a start and run length number of slots/symbols. For example, a set of symbols/slots may be provided to the UE as a type ‘valid’ or “invalid’ with respect to an allowed or a disallowed UL duty cycle evaluation behavior or UL duty cycle counting in a symbol/slot. For example, a set of symbols/slots may be provided to the UE as an assumed or as an indicated reference serving cell UL/DL configuration with respect to 4G/LTE radio access, or as an assumed or as an indicated reference UL/DL configuration with respect to 5G/NR or 6G radio access such as provided in an assumed or indicated tdd-UL-DL-ConfigurationCommon or tdd-UL-DL-ConfigurationDedicated including a set of symbol types ‘D, or ‘U, or ‘F’. For example, a set of symbol/slot identifiers associated with a set of slots/symbols may be indicated to the UE by DCI or provided to the UE by higher layer signaling such as RRC or by MAC CE.

In one example, when the UE receives an UL duty cycle evaluation indication from the gNB wherein the UL duty cycle evaluation behavior corresponds to a prioritized list or a set of carriers or bands, the UE selects a carrier or band from the list or the set. For example, the UE may select a highest priority carrier or band in the band combination, and the UE determines an UL duty cycle with respect to UL transmission in the corresponding carrier or band of the band combination to further determine a maximum output power and/or apply the corresponding transmitter power requirements according to the prioritized list or the set of carriers or bands for the UL duty cycle evaluation.

For example, a UE may be provided with information by the gNB wherein the UL duty cycle evaluation behavior corresponds to a prioritized list of carriers or bands wherein the FR3 6G carrier or band is set to high priority and the FR1 5G/NR or 6G carrier or band is set to low priority. The UE then first selects the higher priority band, i.e., FR3 6G, to determine an UL duty cycle for this band in the band combination, e.g., subject to sufficient UL scheduling or UL transmission activity on the band. For example, the UE may apply an UL duty cycle evaluation or UL duty cycle counting to UL transmissions in the lower priority FR1 5G/NR or 6G band, e.g., when a number or type of UL transmissions in the higher priority band to apply the UL duty cycle evaluation or counting is not sufficient. As can be seen by someone skilled in the art, similar considerations can be applied to other cases such as when multiple priority levels associated with a default or indicated UL duty cycle evaluation behavior or UL duty cycle counting are provided, or to other cases such as when a high, or a medium or a low priority levels are used, or to other cases such as when a priority is provided from a value range, e.g., 1 corresponding to highest priority and 5 corresponding to a lowest priority, or equivalent.

In one embodiment the UE is provided with information for a UL duty cycle evaluation behavior to apply for a first or a second carrier or band in a band combination based on a condition wherein at least one carrier or band is indicated for 6G radio access.

For example, an UL duty cycle evaluation behavior associated with a condition may be provided or indicated to the UE by the gNB based on one of or a combination of DCI-based signaling, L1 control signaling, RRC signaling, MAC CE signaling, or NAS based signaling. For example, an UL duty cycle evaluation behavior corresponding to the first or the second carrier or band may be provided by system operating specifications. For example, an UL duty cycle evaluation behavior corresponding to the first or the second UL duty cycle may be determined by the UE according to a condition.

For example, a UL duty cycle evaluation behavior may be provided, configured or indicated to the UE with respect to one of or a combination of the following conditions:
A symbol or slot type, e.g., a symbol/slot type ‘D’ or ‘F’ or ‘U’; or a symbol/slot of type ‘SBFD’, or of type ‘non-SBFD’ or of type ‘SBFD and non-SBFD’, or ‘valid’ or ‘invalid’
A transmission or allocation bandwidth corresponding to a carrier or an UL signal or UL channel
A TRP or TRPs, e.g., TRP A and/or TRP B, or a CORESETPoolIndex associated with CORESETs for PDCCH receptions, or a TRP identified by one or more SS/PBCH blocks (SSBs).
A number of symbol or slots, e.g., number of consecutive symbols or slots, or number of symbols or slots in a period.
A set of symbol/slot identifiers, e.g., a bitmap, or a list of symbols/slots, or a resource indicator value such as SLIV with starting slot/symbol value and a run length value in an index representation.
An UL signal or channel type, e.g., PUCCH, PUSCH, PRACH or SRS.
A transmission format of an UL signal or UL channel such as PUSCH, or PUCCH, or PRACH, or SRS

In one example, the UE is indicated by the gNB with a slot/symbol type in a carrier or in a band of a band combination on which to apply an UL duty cycle evaluation. In the example, the UE may be indicated a slot/symbol type on which a UL duty cycle evaluation behavior should be applied, i.e., UL transmissions are included into an UL duty cycle evaluation, in the carrier or in the band, or a slot/symbol type on which the UL duty cycle evaluation behavior should not be applied. For example, the UE may be provided with an UL duty cycle evaluation behavior from the gNB wherein a slot/symbol type ‘U’ may correspond to ‘included’ and a slot/symbol type ‘F’ may correspond to ‘not included’.

In one example, a condition associated with a UL duty cycle evaluation behavior may correspond to a minimum number TH for the number of RBs S of a PUSCH allocation on a symbol in a slot in a band of the band combination. The UE counts an UL transmission in the slot in the band with respect to the UL duty cycle when the number S of RBs which is indicated or provided to the UE for the PUSCH allocation on a symbol in the slot is equal to or larger than the minimum number TH; otherwise, the UE does not count the UL transmission.

In one example, a condition associated with a UL duty cycle evaluation behavior may correspond to a maximum number TH for the number of RBs S of a PUSCH allocation on a symbol in a slot in a band of the band combination. The UE counts an UL transmission in the slot in the band with respect to the UL duty cycle when the number S of RBs which is indicated or provided to the UE for the PUSCH allocation on a symbol in the slot is less than a maximum number TH; otherwise, the UE does not count the UL transmission in the slot.

In one example, a condition associated with a UL duty cycle evaluation behavior may correspond to a transmission format of an UL signal or UL channel in a band of the band combination. For example, a transmission format with respect to PUSCH may correspond to one or a combination of the following, an RB allocation, a symbol allocation, a modulation scheme, a modulation order, an MCS, a TBS, a channel coding type or rate, a payload type such as data or UCI/control, a UCI/control payload type such as A/N, or CSI, or CSI part 1, or CSI part 2, or a UCI/control reporting type such as periodic, or semi-persistent, or aperiodic CSI report in the control payload.

For example, a condition or a restriction may correspond to a minimum MCS level TH for the PUSCH transmission in a slot. The UE counts the PUSCH transmission in the band with respect to the UL duty cycle when the MCS for the PUSCH transmission in the band is equal to or larger than the minimum UL MCS level TH, otherwise the UE does not count the PUSCH transmission in the band.

For example, a condition or a restriction may correspond to a maximum MCS level TH for the PUSCH transmission in a slot. The UE counts the PUSCH transmission in the band with respect to the UL duty cycle when the MCS for the PUSCH transmission in the band is larger than the maximum UL MCS level TH, otherwise the UE does not count the PUSCH transmission in the band.

For example, a condition or a restriction may correspond to UCI/control payload type for the PUSCH transmission in a band. The UE counts the PUSCH transmission in the band with respect to the UL duty cycle when the UCI/control payload type is CSI or CSI part 1 or CSI part 2 for the PUSCH transmission in the slot, otherwise, e.g., when the UCI/payload type is HARQ-ACK information, the UE does not count the PUSCH transmission in the band.

In one embodiment the UE is provided with information for an UL duty cycle evaluation behavior to apply for a first or a second carrier or band or a band combination for a duration; wherein at least one carrier or band is indicated for 6G radio access. Based on the provided information, the UE determines a start timing and/or an end timing for the duration to apply a UL duty cycle evaluation behavior in a carrier or in a band or in a band combination.

For example, an UL duty cycle evaluation behavior associated with a duration may be provided or indicated to the UE by the gNB based on one of or a combination of DCI-based signaling, L1 control signaling, RRC signaling, MAC CE signaling, or NAS based signaling. For example, an UL duty cycle evaluation behavior corresponding to the first or the second carrier or band may be provided by system operating specifications. For example, a duration associated with a UL duty cycle evaluation behavior or with UL duty cycle evaluation may be provided to the UE by higher layers. For example, a DCI-based indication may be used to provide the UE with a duration associated with a UL duty cycle evaluation behavior or for the UL duty cycle counting. For example, a duration associated with a UL duty cycle evaluation behavior or UL duty cycle evaluation may be tabulated and/or listed by system operating specifications.

In one example, a UL duty cycle evaluation behavior may be associated with duration T during which a UL duty cycle evaluation behavior corresponding to UL transmission in a carrier or in a band of a band combination is applied not earlier than a start timing or not later than an end timing based on the duration T. The UE applies the UL duty cycle evaluation behavior to UL transmission in the carrier or band when the UL transmission occurs during the duration T. A suitably selected reference timing may be chosen. For example, a duration T corresponding to UL transmissions when the UL duty cycle behavior or the UL duty cycle counting should be applied after receiving a UL duty cycle evaluation indication may correspond to a timing of TH msec or of TH symbols/slots/subframes.

In one embodiment the UE is provided with information for an UL duty cycle evaluation behavior to apply for a first or a second carrier or band or a band combination with respect to an activation timing; wherein at least one band is indicated for 6G radio access. Based on provided information, the UE determines a start timing and/or an end timing for the duration to apply a UL duty cycle evaluation behavior or UL duty cycle evaluation corresponding to an UL transmission in a band of the band combination.

For example, an UL duty cycle evaluation behavior associated with an activation timing may be provided or indicated to the UE by the gNB based on one of or a combination of DCI-based signaling, L1 control signaling, RRC signaling, or MAC CE signaling, or NAS based signaling. For example, an UL duty cycle evaluation behavior corresponding to the first or the second carrier or band may be provided by system operating specifications. For example, an activation timing associated with a UL duty cycle evaluation behavior or with UL duty cycle evaluation may be provided to the UE by higher layers. For example, a DCI-based indication may be used to provide the UE with an activation timing associated with a UL duty cycle evaluation behavior or for the UL duty cycle counting. For example, an activation timing associated with a UL duty cycle evaluation behavior or UL duty cycle evaluation may be tabulated and/or listed by system operating specifications.

In one example, a UL duty cycle evaluation behavior may be associated with an activation timing TH to apply a UL duty cycle evaluation behavior for UL transmission in a band of a band combination. The UE applies the UL duty cycle evaluation behavior to UL transmission in the band with respect to a suitably selected reference timing. For example, a first UL transmission in which to apply the UL duty cycle evaluation behavior or counting in the band after receiving an UL duty cycle evaluation indication may correspond to a timing of TH msec or TH symbols with respect to reception of a PUSCH or a symbol of a PDCCH in which the indication was received by the UE.

Similar considerations based on the examples provided for a duration or an activation timing associated with an UL duty cycle evaluation behavior can be extended to other cases such as when the UE operates according to a band combination across FR1, FR2, or FR3, or according to a band combination within a same frequency range such as within FR1, or within FR2, or within FR3, or to other cases such as when UL transmission in a carrier or in a band are based on 6G radio access or 4G/LTE radio access instead of 5G/NR radio access, or to indication or reporting corresponding to a carrier aggregation operation, or a dual connectivity operation, or a dual active protocol stack operation.

In one embodiment, the UE determines a first evaluation period for a first UL duty cycle associated with UL transmissions corresponding to 5G/NR or 6G radio access in an FR1 carrier or band and a second evaluation period for a second UL duty cycle associated with UL transmissions corresponding to 6G radio access in an FR3 carrier or band, respectively. The UE separately evaluates the number of UL transmissions or the percentage of UL transmissions occurring using the first evaluation period for an UL duty cycle associated with UL transmissions in the 5G/NR or 6G carrier or band and using the second evaluation period for an UL duty cycle in the 6G carrier or band, respectively, in a band combination.

A value for a first and a second evaluation period may be the same or different values can be associated with the first carrier or band, e.g., the 5G/NR or 6G carrier or band, and with the second carrier or band, e.g., the 6G carrier or band, respectively, of the band combination. For example, a value for an evaluation period may correspond to time period or a duration, or may correspond to a threshold value. For example, a value for a second evaluation period may be determined based on the value for a first evaluation period and a minimum, or a maximum, or a scaling value, or an offset value, or a threshold value. For example, a minimum, or a maximum, or an adjusted or an assumed value for the second evaluation period to determine a second UL duty cycle in a second carrier or band may be determined with reference to a first evaluation period to determine a first UL duty cycle in a first carrier or band. For example, a value for an evaluation period associated with an FR3 6G band in a band combination may be defined with reference to a minimum value, e.g., at least, or a maximum value, e.g., not exceeding, or a range of values, e.g., not less than X msec but not exceeding Y msec, provided or assumed for an FR1 5G/NR or 6G band in the band combination.

In one example, an evaluation period for the UL duty cycle for an FR1 5G/NR or 6G band in a band combination may correspond to a minimum value, e.g., T_{eval,FR1}=1 msec but a separate evaluation period for an FR3 6G band in the band combination may correspond to T_{eval,FR3}=0.5 msec. For example, a default value for an evaluation period associated with a first or a second carrier or band in the band combination may be indicated or tabulated or provided by system operating specifications. Furthermore, a default value for an evaluation period associated with an UL duty cycle evaluation in the first or the second carrier or band may be provided or indicated to the UE or tabulated by system operating specifications.

In one embodiment, an UL duty cycle evaluation indication may be provided for or indicated to the UE by the gNB based on one of or a combination of DCI-based signaling, L1 control signaling, RRC signaling, or MAC CE based signaling.

For example, an UL duty cycle evaluation behavior may be provided, configured or indicated to the UE based on one of or a combination of DCI-based signaling, or L1 control signaling, or RRC signaling, or MAC CE based signaling, or NAS based signaling. Based on an UL duty cycle evaluation indication, the UE can determine an UL duty cycle evaluation behavior and/or the UE can apply an UL duty cycle evaluation for a carrier or for a band in a band combination. Using the UL duty cycle evaluation behavior to apply an UL duty cycle evaluation on a carrier or in a band, the UE can further determine a maximum output power and/or apply the corresponding transmitter power requirements according to the determined or selected UE Power Class for UL transmissions in the band of the band combination.

For example, a configuration associated with an UL duty cycle evaluation behavior or with an UL duty cycle evaluation may be provided to the UE by higher layers. For example, a DCI-based indication may be used to provide the UE with information associated with an UL duty cycle evaluation behavior or with an UL duty cycle evaluation. For example, an UL duty cycle evaluation behavior may be tabulated and/or listed by system operating specifications. A configuration for an UL duty cycle evaluation behavior may be provided by higher layers to the UE and used in conjunction with DCI-based indication by the UE to determine an UL duty cycle evaluation behavior or to apply an UL duty cycle evaluation. For example, the DCI can indicate an UL duty cycle from a set of RRC-configured UL duty cycles. If the same UL duty cycle evaluation behavior can be provided for multiple UEs, a common DCI or common RRC signaling message may be used. A UE-specific DCI or RRC signaling of dedicated or common type may be used to provide information associated with an UL duty cycle evaluation behavior to a UE. A value or a set of values may be associated with a parameter for an UL duty cycle evaluation behavior. For example, a UE may select or determine a value from the set of values associated with an UL duty cycle evaluation behavior based on an index value indicated through a DCI format or through MAC-CE signaling wherein the UE may select from one or more entries provided in an RRC configurable table associated with an index value. The UE may determine a default condition or a default value associated with an UL duty cycle evaluation behavior.

In one example, an UL duty cycle evaluation behavior is provided to the UE using higher layer signaling. For example, a UE may be provided with a configuration of an UL duty cycle evaluation behavior based on a higher layer parameter such as ServingCellConfig or PUSCH-Config.

In one example, a PUSCH time-domain resource allocation (TDRA) table may be configured for the UE by higher layers and include a parameter associated with an UL duty cycle evaluation behavior. For example, the PUSCH time-domain resource allocation table may be configured for the UE by higher layers and include a parameter associated with an UL duty cycle evaluation behavior, e.g., for a row of the PUSCH TDRA table or as a parameter provided in the configuration for the PUSCH TDRA table. For example, the UE may be indicated an entry of the PUSCH TDRA table associated with an UL duty cycle evaluation behavior using a TDRA field in a DCI format. For example, a PUSCH TDRA table associated with an UL duty cycle evaluation behavior corresponding to an UL transmission may be used based on a configured grant.

In one example, a power control configuration may be provided to the UE by higher layers or tabulated by system operating specifications and include a parameter associated with an UL duty cycle evaluation behavior. For example, the power control configuration may include a closed loop TPC adjustment value such as +1 dB or −3 dB and include a parameter associated with an UL duty cycle evaluation behavior. For example, the UE may be indicated an entry of the power control configuration associated with an UL duty cycle evaluation behavior using a TPC command for scheduled PUSCH field in a DCI format or using a dedicated field in the DCI format.

In one example, information may be provided to the UE by higher layers to associate a DL or UL reference signal or a DL or an UL or joint TCI state(s) or RS resource index(es) such as corresponding to an SSB or to a CSI-RS resource index with an UL duty cycle evaluation behavior for an UL transmission. For example, a first TCI state may correspond to an UL transmission for a first UL duty cycle evaluation behavior in a first band, and a second TCI state may correspond to an UL transmission for a second UL duty cycle evaluation behavior in a second band, wherein the first and second bands can be same or different. For example, a PUSCH transmission scheduled by a DCI format in a PDCCH can be associated a first UL duty cycle evaluation behavior in a first band when the PDCCH is received in a CORESET with a first value for CORESETPoolIndex, and be associated with second UL duty cycle evaluation behavior in a second band when the PDCCH is received in a CORESET with a second value for CORESETPoolIndex, wherein the first and second bands can be same or different.

Similar considerations can be applied to other cases such as when an UL duty cycle evaluation behavior is provided to the UE using CN based signaling or to other cases such as when an UL duty cycle evaluation behavior may be provided, e.g., stored or provisioned for the UE based on a USIM/UICC and related protocol signaling.

For example, the UE may indicate or report to the gNB a supported UL duty cycle evaluation behavior for a band using 6G radio access in a band combination using higher layer signaling such as an RRC UECapabilityInformation message. For example, the UE may indicate or report to the gNB a supported UL duty cycle evaluation behavior associated with operation in an FR3 6G band or band combination in UE radio access capability information. For example, a gNB may initiate a procedure using a UECapabilityEnquiry message.

In one example, the UE indicates or reports to the gNB a supported UL duty cycle evaluation behavior for the bands in a band combination in a UE radio access capability information wherein the UL duty cycle evaluation behavior may correspond to a same, or a separate, or a joint or common type of UL duty cycle evaluation for the bands in the band combination; and wherein one or more bands may use 6G radio access.

In one example, the UE indicates or reports to the gNB a duration or a value for activation timing associated with an UL duty cycle evaluation behavior for the bands in a band combination wherein one or more bands may use 6G radio access.

In one example, the UE indicates or reports to the gNB a supported UL duty cycle evaluation behavior for a first or a second band in the band combination in a UE radio access capability information wherein the UL duty cycle evaluation behavior corresponds to an ordering or a sequence of carriers or bands corresponding to which the UE may apply an UL duty cycle evaluation, e.g., indicative of a carrier or a band in the band combination based on which UL duty cycle evaluation may be applied first or last by the UE; wherein one or more bands may use 6G radio access.

For example, the UE may indicate to the gNB a desired, a preferred, or a priority-based UL duty cycle evaluation behavior for a band using 6G radio access in a band combination using higher layer signaling such as a higher layer RRC UEAssistanceInformation message, wherein one or more bands may use 6G radio access.

In one example, the UE indicates to the gNB a desired or a preferred UL duty cycle evaluation behavior for a first and/or a second band in a band combination including a band using 6G radio access wherein the UL duty cycle evaluation behavior may correspond to a same, or a separate, or a joint or common type of UL duty cycle evaluation.

In one example, the UE indicates to the gNB a desired or a preferred UL duty cycle evaluation behavior for a first or a second band in the band combination in a UE radio access capability information wherein the UL duty cycle evaluation behavior corresponds to an ordering or a sequence of carriers or bands corresponding to which the UE may apply an UL duty cycle evaluation, e.g., indicative of a carrier or a band in the band combination on which an UL duty cycle evaluation may be applied first or last by the UE; wherein one or more bands may use 6G radio access.

In one example, the UE indicates or reports to the gNB a value for a first UL duty cycle associated with UL transmissions in a first 5G/NR or 6G band and a value for a second UL duty cycle associated with a second 6G band, respectively, wherein the first or the second band may correspond to an FR1 band or an FR3 band.

Similar considerations based on the examples provided for the RRC UECapabilityInformation or UECapabilityEnquiry messages can be extended to other cases such as when the UE operates according to a band combination across FR1, FR2, or FR3, or according to a band combination within a same frequency range such as within FR1, or within FR2, or within FR3, or to other cases such as when UL transmission in a carrier or in a band are based on 6G radio access or 4G/LTE radio access instead of 5G/NR radio access, or to indication or reporting corresponding to a carrier aggregation operation, or a dual connectivity operation, or a dual active protocol stack operation.

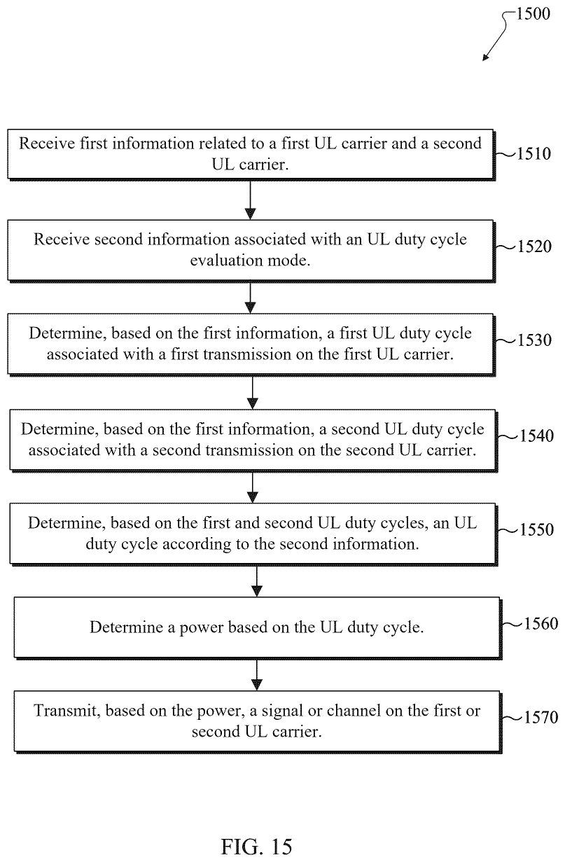

FIG. 15 illustrates an example method 1500 performed by a UE in a wireless communication system according to embodiments of the present disclosure. The method 1500 of FIG. 15 can be performed by any of the UEs 111-115 of FIG. 1, such as the UE 115 of FIG. 3, and a corresponding method can be performed by any of the BSs 101-103 of FIG. 1, such as BS 102 of FIG. 2. The method 1500 is for illustration only and other embodiments can be used without departing from the scope of the present disclosure.

The method 1500 begins with the UE receiving first information related to a first UL carrier and a second UL carrier (1510). For example, the first information is associated with UL carrier aggregation. The UE then receives second information associated with an UL duty cycle evaluation mode (1520). In various embodiments, the second information includes an indication corresponding to the UL duty cycle evaluation mode, and the UE determines the UL duty cycle based on the indication. The UE then determines, based on the first information, a first UL duty cycle associated with a first transmission on the first UL carrier (1530). The UE then determines, based on the first information, a second UL duty cycle associated with a second transmission on the second UL carrier (1540). For example, the first or the second information includes maximum values for the first and second UL duty cycles.

The UE then determines, based on the first and second UL duty cycles, an UL duty cycle according to the second information (1550). In various embodiments, the UL duty cycle evaluation mode corresponds to a jointly determined UL duty cycle for the first transmission on the first UL carrier and for the second transmission on the second UL carrier in a same time-domain resource, and the UE determines the jointly determined UL duty cycle based on the first or second UL duty cycle and an adjustment factor. In various embodiments, the UE determines the UL duty cycle as one of a maximum value of the first and second UL duty cycles, an average or weighted average value of the first and second UL duty cycles, or a scaled or adjusted average value based on the first or second UL duty cycles using an adjustment factor.

The UE then determines a power based on the UL duty cycle (1560). The UE then transmits, based on the power, a signal or channel on the first or second UL carrier (1570). In various embodiments, the UE transmits, via UCI, a MAC CE, or a RRC message, values for first and second supported or indicated UL duty cycle corresponding to the first and second UL carriers, respectively, or a value for a supported or indicated UL duty cycle evaluation mode corresponding to the first and second UL carriers.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for operating a user equipment (UE), the method comprising:
receiving first information related to a first uplink (UL) carrier and a second UL carrier;
receiving second information associated with an UL duty cycle evaluation mode;
determining, based on the first information, a first UL duty cycle associated with a first transmission on the first UL carrier;
determining, based on the first information, a second UL duty cycle associated with a second transmission on the second UL carrier;
determining, based on the first and second UL duty cycles, an UL duty cycle according to the second information;
determining a power based on the UL duty cycle; and
transmitting, based on the power, a signal or channel on the first or second UL carrier.

2. The method of claim 1, wherein the first information is associated with UL carrier aggregation.

3. The method of claim 1, wherein:
the UL duty cycle evaluation mode corresponds to a jointly determined UL duty cycle for the first transmission on the first UL carrier and for the second transmission on the second UL carrier in a same time-domain resource, and
the method further comprising determining the jointly determined UL duty cycle based on (i) the first or second UL duty cycle and (ii) an adjustment factor.

4. The method of claim 1, wherein determining the UL duty cycle further comprises determining the UL duty cycle as one of:
a maximum value of the first and second UL duty cycles,
an average or weighted average value of the first and second UL duty cycles, or
a scaled or adjusted average value based on the first or second UL duty cycles using an adjustment factor.

5. The method of claim 1, wherein:
the second information includes an indication corresponding to the UL duty cycle evaluation mode, and
determining the UL duty cycle further comprises determining the UL duty cycle based on the indication.

6. The method of claim 1, further comprising transmitting, via uplink control information (UCI), a medium-access-control (MAC) control element (CE), or a radio resource control (RRC) message, (i) values for first and second supported or indicated UL duty cycle corresponding to the first and second UL carriers, respectively, or (ii) a value for a supported or indicated UL duty cycle evaluation mode corresponding to the first and second UL carriers.

7. The method of claim 1, wherein the first or the second information includes maximum values for the first and second UL duty cycles.

8. A user equipment (UE), comprising:
a transceiver configured to:
receive first information related to a first uplink (UL) carrier and a second UL carrier; and
receive second information associated with an UL duty cycle evaluation mode; and
a processor operably coupled to the transceiver, the processor configured to:
determine, based on the first information, a first UL duty cycle associated with a first transmission on the first UL carrier;
determine, based on the first information, a second UL duty cycle associated with a second transmission on the second UL carrier;
determine, based on the first and second UL duty cycles, an UL duty cycle according to the second information; and
determine a power based on the UL duty cycle,
wherein the transceiver is further configured to transmit, based on the power, a signal or channel on the first or second UL carrier.

9. The UE of claim 8, wherein the first information is associated with UL carrier aggregation.

10. The UE of claim 8, wherein:
the UL duty cycle evaluation mode corresponds to a jointly determined UL duty cycle for the first transmission on the first UL carrier and for the second transmission on the second UL carrier in a same time-domain resource, and
the processor is further configured to determine the jointly determined UL duty cycle based on (i) the first or second UL duty cycle and (ii) an adjustment factor.

11. The UE of claim 8, wherein the processor is further configured to determine the UL duty cycle as one of:
a maximum value of the first and second UL duty cycles,
an average or weighted average value of the first and second UL duty cycles, or
a scaled or adjusted average value based on the first or second UL duty cycles using an adjustment factor.

12. The UE of claim 8, wherein:
the second information includes an indication corresponding to the UL duty cycle evaluation mode, and
the processor is further configured to determine the UL duty cycle based on the indication.

13. The UE of claim 8, wherein the transceiver is further configured to transmit, via uplink control information (UCI), a medium-access-control (MAC) control element (CE), or a radio resource control (RRC) message, (i) values for first and second supported or indicated UL duty cycle corresponding to the first and second UL carriers, respectively, or (ii) a value for a supported or indicated UL duty cycle evaluation mode corresponding to the first and second UL carriers.

14. The UE of claim 8, wherein the first or the second information includes maximum values for the first and second UL duty cycles.

15. A base station (BS), comprising:
a processor; and
a transceiver operably coupled to the processor, the transceiver configured to:
transmit first information related to a first uplink (UL) carrier and a second UL carrier, wherein a first UL duty cycle is associated with a first transmission on the first UL carrier and wherein a second UL duty cycle is associated with a second transmission on the second UL carrier;
transmit second information associated with an UL duty cycle evaluation mode; and
receive a signal or channel on the first or second UL carrier,
wherein a power for transmission of the signal or channel is based on an UL duty cycle determined based on the first and second UL duty cycles according to the second information.

16. The BS of claim 15, wherein the first information is associated with UL carrier aggregation.

17. The BS of claim 15 wherein:
the UL duty cycle evaluation mode corresponds to a jointly determined UL duty cycle for the first transmission on the first UL carrier and for the second transmission on the second UL carrier in a same time-domain resource, and
the jointly determined UL duty cycle is based on (i) the first or second UL duty cycle and (ii) an adjustment factor.

18. The BS of claim 15, wherein the UL duty cycle is one of:
a maximum value of the first and second UL duty cycles,
an average or weighted average value of the first and second UL duty cycles, or
a scaled or adjusted average value based on the first or second UL duty cycles using an adjustment factor.

19. The BS of claim 15, wherein:
the second information includes an indication corresponding to the UL duty cycle evaluation mode, and
the UL duty cycle is based on the indication.

20. The BS of claim 15, wherein the transceiver is further configured to receive, via uplink control information (UCI), a medium-access-control (MAC) control element (CE), or a radio resource control (RRC) message, (i) values for first and second supported or indicated UL duty cycle corresponding to the first and second UL carriers, respectively, or (ii) a value for a supported or indicated UL duty cycle evaluation mode corresponding to the first and second UL carriers.
